(19) United States
(12) Patent Application Publication
(10) Pub. No.: US 2013/0309637 A1
(43) Pub. Date: Nov. 21, 2013

(54) Consumer Information and Sensing System for Consumables and Cosmetic Substances

(71) Applicant: Eugenio Minvielle, Rye, NY (US)

(72) Inventor: Eugenio Minvielle, Rye, NY (US)

(21) Appl. No.: 13/948,078

(22) Filed: Jul. 22, 2013

Related U.S. Application Data
(63) Continuation-in-part of application No. 13/937,167, filed on Jul. 8, 2013.
Application No. 13/937,167 is a continuation-in-part of application No. 13/732,050, filed on Dec. 31, 2012.
Application No. 13/732,050 is a continuation-in-part of application No. 13/485,878, filed on May 31, 2012.
(60) Provisional application No. 61/624,800, filed on Apr. 16, 2012.
(60) Provisional application No. 61/624,980, filed on Apr. 16, 2012.
(60) Provisional application No. 61/624,989, filed on Apr. 16, 2012.

(51) Int. Cl. G09B 19/00

(52) U.S. Cl. CPC G09B 19/00; G09B 19/0092
USPC 434/127; 434/430

(57) ABSTRACT

A consumer information and sensing system for consumables and cosmetic substances. The consumer information and sensing system tracks an determines information regarding the efficacy state of consumables and cosmetic substances, obtains input from consumers regarding a desired efficacy state at consumption, and provides an indoor navigation system to locate such consumables and cosmetic substances.

### RELATED PATENT APPLICATIONS

This application is continuation-in-part of Utility application U.S. Ser. No. 13/937,167 filed Jul. 8, 2013, titled “CONSUMER INFORMATION AND SENSING SYSTEM FOR NUTRITIONAL SUBSTANCES,” which is a continuation-in-part of Utility application U.S. Ser. No. 13/732,050 filed Dec. 31, 2012, which is a continuation-in-part of Utility application U.S. Ser. No. 13/485,878 filed May 31, 2012, which claims priority to U.S. Provisional Patent Application Ser. No. 61/624,800, filed Apr. 16, 2012; U.S. Provisional Patent Application Ser. No. 61/624,980, filed Apr. 16, 2012; and U.S. Provisional Patent Application, 61/624,989, filed Apr. 16, 2012, the contents of which are all incorporated herein by reference in their entirety.

### FIELD OF THE INVENTION

Inventions relate to consumer information systems for consumables and cosmetic substances using information regarding consumables and cosmetic substance creation, preservation, transformation, dispensing, sensed values related to a current efficacy state, and consumer preference information, for tracking consumer's needs and preferences and providing feedback to creators, preservers, transformers, dispensers, and consumers of consumables and cosmetic substances.

### BACKGROUND OF THE INVENTION

Consumables and cosmetic substances are traditionally grown (plants), raised (animals) or synthesized (synthetic compounds). Additionally, consumables and cosmetic substances can be found in a wild, non-cultivated form, which can be caught or collected. While the collectors and creators of consumables and cosmetic substances generally obtain and/or generate information about the source, history, efficacy content and/or efficacy content of their products, they generally do not pass such information along to the users of their products. One reason is the consumables and cosmetic substance industries have tended to act like “silo” industries. Each group in the consumables and cosmetic industry: growers, packagers, processors, distributors, retailers, and preparers work separately, and either shares no information, or very little information, between themselves. There is generally no consumer access to, and little traceability of, information regarding the creation and/or origin, preservation, processing, preparation, dispensing, or consumption of consumables and cosmetic substances. It would be desirable for such information be available to the consumers of consumables and cosmetic substances, as well as all participants in the consumables and cosmetic industry—the consumables and cosmetic substance supply system.

While the consumables and cosmetic substances supply system has endeavored to increase the efficacy value of the consumables and cosmetic substances it produces, it has not provided a means of tracking the evolution of consumables and cosmetic substances efficacy value in a manner that makes information regarding the evolution available, useful, or responsive to consumers. The efficacy value of consumables and cosmetic substances refers to the portion of these consumables and cosmetic substances which are beneficial to the organisms which use them. Examples of the efficacy value of consumables and cosmetic substances could include: particular Aloe vera derived phytochemical concentrations in skin lotion; antibiotic concentration in antibiotic ointment; percent by weight of Naproxen in a pain pill; concentration of Omega oil in a dietary supplement; concentration of tea tree oil in a shampoo; concentration of tetrahydrozoline hydrochloride in eye drops; Vitamin C level in a vitamin pill; specific amino-acid protein levels in lip stick; amount of epinephrine in an emergency epinephrine injector; the concentration of Hydrogen Peroxide in a bottle of antiseptic; and an amount or concentration of any other component which is necessary, or at least beneficial, to the organism using the consumables and cosmetic substances.

While there has recently been greater attention by consumer organizations, health organizations and the public to the efficacy value of consumables and cosmetic substances, the consumables and cosmetic substance industry has been slow in responding to this attention. One reason for this may be that since the consumables and cosmetic substance industry operates as silos of those who create consumables and cosmetic substances, those who preserve and transport consumables and cosmetic substances, those who transform consumables and cosmetic substances, and those who finally prepare the consumables and cosmetic substances for use by the consumer, there has been no system wide coordination or management of efficacy value, and no practical way for creators, preservers, transformers, dispensers, and consumers to update labeling content for consumables and cosmetic substances. While each of these silo industries may be able to maintain or increase the efficacy value of the consumables and cosmetic substances they handle, each silo industry has only limited information and control of the consumables and cosmetic substances they receive, and the consumables and cosmetic substances they pass along, and the limited information in their control provides little utility beyond tracking product inventory and predetermined expiration dates.

As consumers better understand their need for consumables and cosmetic substances with higher efficacy value, they will start demanding that the consumables and cosmetic substance industry offer products which include higher efficacy value, and/or at least information regarding efficacy value of such products, as well as information regarding the source, creation and other origin information for the consumables and cosmetic substance. As societies and governments seek to improve their constituents' health and lower healthcare costs, incentives and/or mandates will be given to the consumables and cosmetic substance industry to track, maintain, and/or increase the efficacy value of consumables and cosmetic substances they handle. There will be a need, not only within each consumables and cosmetic substance industry silo to maintain or improve the efficacy value of their products, but an industry-wide solution to allow the management and tracking of evolving efficacy values across the entire cycle from creation to use. In order to manage the efficacy value of consumables and cosmetic substances across the entire cycle from creation to use, the consumables and cosmetic substance industry will need to identify, track, measure, estimate, preserve, transform, dispense, and record efficacy value for consumables and cosmetic substances. Of particular importance is the measurement, estimation, and tracking of changes to the efficacy content of a consumables and cosmetic substance from creation to use. This information could be used, not only by the consumer in selecting and dispensing particular consumables and cosmetic substances, but could be used by the other consumables and cosmetic substance industry silos, including creation, preservation, transformation, and dispensing, to make decisions on how to create, handle and process consumables and cosmetic substances. Additionally, those who sell consumables and cosmetic substances to consumers could communicate perceived qualitative values of the consumables and cosmetic substance in their efforts to market and position their consumables and cosmetic substance products. Further, a determinant of price of the consumables and cosmetic substance could be particular efficacy values, and if changes to those values are perceived as desirable. For example, if a desirable efficacy value has been maintained, improved, or minimally degraded, the corresponding consumables and cosmetic substance could be marketed as a premium product. Still further, a system allowing creators, preservers, transformers, and applicators of consumables and cosmetic substances to update labeling content to reflect the most current information about the consumables and cosmetic substances would provide consumers with the information they need to make informed decisions regarding the consumables and cosmetic substances they purchase and use. Such information updates could include efficacy values of the consumables and cosmetic substance, and may further include information regarding the source, creation and other origin information for the consumables and cosmetic substance.

For example, the grower of Aloe vera generally only provides basic information such as the variety and grade of its Aloe vera leafs to an Aloe vera transformer, who extracts juices from the Aloe vera leafs, concentrates the extract, and preserves and ships the concentrate to another transformer, a skin lotion transformer, for use as an ingredient in skin lotion. The Aloe vera transformer may only tell the skin lotion transformer that the Aloe vera extract has been concentrated and frozen after extraction. The skin lotion transformer may only provide the consumer with rudimentary instructions of how to apply the skin lotion and only tell the consumer that the skin lotion contains Aloe vera extract among its ingredients. Finally, the consumer of the skin lotion will likely keep her opinions on the quality of the skin lotion to herself, unless it was an especially bad experience, where she might contact the skin lotion transformer's customer support program to complain. Very minimal, or no, information on the efficacy content of the skin lotion related to the Aloe vera extract is passed along to the consumer. The consumer knows essentially nothing about changes (generally a degradation, but could be a maintenance or even an improvement) to the efficacy content of the skin lotion related to the Aloe vera extract, particularly related to Aloe vera derived phytochemical concentrations in the skin lotion, which have occurred from creation, transformation, preservation, local storage, or dispensing. The consumer is even more unlikely to be aware of possible changes to labeling content that a creator, preserver, or transformer may just have become be aware of, such as changes in information about efficacy values of the skin lotion or changes in information regarding the source, creation and other origin information about the skin lotion or its ingredients. If communicated, such changes to labeling content could affect the purchase, local storage, dispensing, and use of the skin lotion. Further, if communicated, such changes to labeling content could affect the health, safety, and wellbeing of the consumer. It is also clear that such changes would best be communicated rapidly and by a means readily utilized by the consumer.

Consumers' needs are changing as consumers are demanding more of consumables and cosmetic substances. Consumers are also asking for more information about the consumables and cosmetic substances they consume, such as specific characteristics' relating not only to efficacy values, but to allergens, irritants, substitutions, and adulteration. For example, consumables and cosmetic substances which contain latex, dyes, ingredients derived from particular animal or plant sources, preservatives, hormones or hormones, antibiotics, etc. need to be avoided by certain consumers. However, the transformer of the skin lotion, in the prior example, has very little information to share other than possibly the source of the ingredients of the skin lotion and its processing steps in manufacturing the skin lotion. The transformer of the skin lotion does not know the efficacy value of the product after it has been locally stored and is ready for dispensing by the consumer, cannot predict changes to the efficacy value, and cannot inform a consumer of this information to enable the consumer to better meet their needs. For example, the consumer of the skin lotion may want to know what changes have occurred to efficacy values related to particular phytochemicals derived from Aloe vera, and what residual efficacy values remain, when it is purchased, during local storage in her house, and upon dispensing. Such changes in efficacy values are usually a degradation, but could be a maintenance or even improvement. There is a need to preserve, measure, estimate, store and/or transmit information regarding such efficacy values, including changes to these values, throughout the consumables and cosmetic substance supply system. Additionally, given the opportunity and a system capable of receiving and processing real time consumer feedback and updates regarding changes in the efficacy value of consumables and cosmetic substances, consumers can even play a role in updating dynamic information about the consumables and cosmetic substances they have purchased and/or are prepared to consume, such that the information is available and useful to others in the consumables and cosmetic substance supply system. Ideally, equipment and environments for local storage of consumables and cosmetic substances by consumers, such as any storage location, medicine cabinet, portable container, tray, bag, and so forth, could interact with consumables and cosmetic substance to provide such consumer feedback and updates, and preferably are utilized to meet the particular consumer's needs.

The efficacy value information for consumables and cosmetic substances provided to consumers is often minimal. When efficacy value information is provided, it is static in nature, and most likely to reflect an initial efficacy value of the corresponding consumables and cosmetic substance. There is a need to provide information about consumables and cosmetic substances in a meaningful manner. Such information needs to be presented in a manner that is responsive to the specific needs of a particular consumer. For example, consumers with a medical dispense, such as diabetes, would want to track specific information regarding efficacy values associated with Insulin medicaments they purchase, locally store, and dispense, and would benefit further from knowing changes in the efficacy values or having tools to quickly indicate or estimate these changes in a retrospective, current, or prospective fashion, and even tools to report these changes, or impressions of these changes, in a real-time fashion. Consumers would want to track specific efficacy values of consumables and cosmetic substances to be aware of changes in their efficacy values, particularly a degradation in efficacy values, and for potential interactions with other consumables and cosmetic substances they are consuming or plan to consume or consumables and cosmetic substances they are consuming or plan to consume.

In fact, each silo in the consumables and cosmetic substance industry already creates and tracks some information, including efficacy value information, about their product internally. For example, the famer who grew the Aloe vera leafs knows the variety of plant, dispense of the soil, the source of the water, the fertilizers and pesticides used, and can measure the leafs' efficacy content at creation. The Aloe vera extract transformer knows when it was picked, how it was transported to his processing facility, how the Aloe vera leafs were preserved, the juice extracted, concentrated, frozen, and preserved before being sent to the skin lotion transformer, when it was delivered to the skin lotion transformer, and may know what degradation to efficacy value has occurred during extraction and concentration. The skin lotion transformer likely knows the source of each ingredient of the skin lotion, how it was processed, including the processing parameters followed at his processing facility, and how it was preserved and packaged for the consumer. Not only may the skin lotion transformer know what degradation to efficacy value occurred while processing the skin lotion, it may modify its processing and post-processing preservation to minimally affect the efficacy value. Finally, a consumer generally knows how she has locally stored the skin lotion after she has purchased it, how she used the skin lotion, and whether she did or did not enjoy it.

If there was a mechanism to share this information, the quality of consumables and cosmetic substances, including efficacy values, could be preserved and improved. Consumers could be better informed about consumables and cosmetic substances they select and consume, including the state, and changes in the state, of the efficacy value of the consumables and cosmetic substance throughout its lifecycle from creation to consumption. The efficiency and cost effectiveness of consumables and cosmetic substances could also be improved. Feedback within the entire chain from creator to consumer could provide a closed-loop system that could improve overall quality, efficiency value, product value and profit. For example, in the pharmaceutical supply chain, much of the product is wasted due to safety margins included in static product expiration dates. The use of more accurate tracking information, measured quality information, including historical environmental information and efficacy value information could substantially reduce such waste. Collecting, preserving, measuring and/or tracking information about a consumables and cosmetic substance in the consumables and cosmetic substance supply system, would allow needed accountability. There would be nothing to hide.

As consumers are demanding more information about consumables and cosmetic substances they consume, they are asking for products that have higher efficacy value and would like consumables and cosmetic products to actually meet their specific requirements, particularly their needs regarding desired efficacy content of a dispensed consumables and cosmetic substance. While consumers, and all those who process, sell, and dispense consumables and cosmetic substances may obtain some information from current consumables and cosmetic substance tracking systems, such as labels, these current systems can provide only limited information.

Current packaging materials for consumables and cosmetic substances include plastics, paper, cardboard, glass, and synthetic materials. Generally, the packaging material is chosen by the manufacturer to best preserve the quality of the consumables and cosmetic substance until used by the customer. The packaging typically includes some information regarding the type of consumables and cosmetic substance, identity of the producer, country of origin, recommendations for use, expiration date, and warnings. Such packaging generally does not transmit or communicate source information of the consumables and cosmetic substance or its ingredients, such as creation information, current or historic information as to the external dispenses of the packaged consumables and cosmetic substance, or current or historic information as to the internal dispenses of the packaged consumables and cosmetic substance.

Traditional consumables and cosmetic substance manufacturers take consumables and cosmetic substance ingredients from creators, preservers, and other transformers and transform them into consumables and cosmetic substances for use by consumers. It is understood that in some cases, consumables and cosmetic substance transformers may pass consumables and cosmetic substances they have transformed on to other consumables and cosmetic substance transformers, or to those who dispense consumables and cosmetic substances to consumers, such as to compounding pharmacies, doctor's offices, and hospitals. While these consumables and cosmetic transformers have some knowledge of the consumables and cosmetic substance ingredients they purchase, and make such selections to meet the needs of the consumers of their products, they generally do not transmit that information along to the consumers, nor change the way they transform the consumables and cosmetic substances based on the history or current dispense of the consumables and cosmetic substances they receive for transformation.

Consumers of consumables and cosmetic substances are typically provided with recommendations regarding the use of consumables and cosmetic substances they have obtained. Such recommendations may include, but are not limited to: usage quantity, such as, but not limited to, dosage, volume, or weight; how to take, apply, use, or otherwise consume; frequency of use; and so forth, and are referred to herein as dispensing parameters. Current dispensing parameters are static in nature, and based on assumed efficacy values of the corresponding consumables and cosmetic substance, typically the initial efficacy values of the corresponding consumables and cosmetic substance. However, the consumer has no way of knowing the history or current dispense of the consumables and cosmetic substances they have obtained, particularly as it relates to efficacy values, at the time they obtain it, during the time it is locally stored by the consumer, or at the time it is dispensed for consumption. It is understood that as used herein, consumption of consumables and cosmetic substances refers to any end use or application of the consumables and cosmetic substances by a consumer, and may include, but is not limited to, ingestion, injection, inhalation, topical application, and any other known formats for use or end application. Further, consumers have no way to change the way they locally store, dispense and consume the consumables and cosmetic substances based on the history or current dispense of the consumables and cosmetic substances.

All through the consumables and cosmetic substance supply and consumption chain the various suppliers benefit from feedback from consumers further up the supply chain. However, such feedback is disorganized and haphazard and can only be traced generally to the actual consumables and cosmetic substances being commented on.

An important issue in the creation, preservation, transformation, dispensing, and consumption of consumables and cosmetic substances are the changes that occur in consumables and cosmetic substances due to a variety of internal and external factors. Because consumables and cosmetic substances are composed of biological, organic, and/or chemical compounds, they are generally subject to degradation. This degradation generally reduces the efficacy values of consumables and cosmetic substances. While not always true, consumables and cosmetic substances have their highest efficacy content when they are created. Currently, the consumables and cosmetic substance industry attempts to minimize the loss of efficacy values, often through the use of additives or preservatives and often through storing the consumables and cosmetic substance at specific, often narrow, storage dispenses, and/or attempts to hide the loss of efficacy values from consumers. Consumers are provided with virtually no tools to help them in their attempts to determine and minimize the loss of efficacy values of the consumables and cosmetic substances they acquire, locally store, dispense, and consume.

Overall, the examples herein of some prior or related systems and their associated limitations are intended to be illustrative and not exclusive. Other limitations of existing or prior systems will become apparent to those of skill in the art upon reading the following Detailed Description.

### OBJECTS OF THE INVENTION

In an object of the present invention consumer feedback is obtained related to the dispensing and consumption of the consumables and cosmetic substance, including feedback regarding changes in efficacy values of the consumables and cosmetic substance, herein referred to as ΔE, desired by consumers, and provided to one or more of the consumables and cosmetic substance creator, packager, transformer, dispenser, and/or consumer.

In an object of the present invention a multi-dimensional consumables and cosmetic substance database receiving and transmitting consumer feedback on the dispensing and consumption of consumables and cosmetic substances is provided, including feedback regarding changes in efficacy values of consumables and cosmetic substances, herein referred to as ΔE, desired by consumers, for use and analysis by the consumables and cosmetic substance creator, packager, transformer, dispenser, and/or consumer.

In an object of the present invention the sensing of efficacy attribute values corresponding to a current efficacy state of a consumables and cosmetic substance is enabled.

In a further object of the present invention a current efficacy state of a consumables and cosmetic substance is determined by comparing its current efficacy attribute values to a database of efficacy attribute values for known consumables and cosmetic substances in known efficacy states.

In an object of the present invention, degradation of efficacy value of consumables and cosmetic substances is minimized and/or tracked through collection, storage, and/or transmission of information regarding this degradation.

### SUMMARY OF THE INVENTION

In an embodiment, consumer input related to dispensing or consumption of a consumables and cosmetic substance, including input regarding changes in efficacy values of the consumables and cosmetic substance, herein referred to as ΔE, desired by a consumer, is obtained from the consumer and related feedback is provided to one or more of the consumables and cosmetic substance creator, packager, transformer, dispenser, and/or consumer.

In an embodiment, a multi-dimensional consumables and cosmetic substance database can be provided for receiving and transmitting consumer feedback related to dispensing or consumption of consumables and cosmetic substances, including feedback regarding changes in efficacy values of consumables and cosmetic substances, herein referred to as ΔE, desired by the consumer, for use and analysis by the consumables and cosmetic substance creator, packager, transformer, dispenser, and/or consumer.

In an embodiment, sensors are provided to enable the sensing of efficacy attribute values corresponding to a current efficacy state of a consumables and cosmetic substance.

In a further embodiment, a current efficacy state of a consumables and cosmetic substance is determined by comparing its currently sensed efficacy attribute values to a database of sensed efficacy attribute values for known consumables and cosmetic substances in known efficacy states.

In an embodiment, degradation of efficacy value of consumables and cosmetic substances is minimized and/or tracked through the collection, storage, and/or transmission of information related to degradation.

Other advantages and features will become apparent from the following description and claims. It should be understood that the description and specific examples are intended for purposes of illustration only and not intended to limit the scope of the present disclosure.

### BRIEF DESCRIPTION OF THE DRAWINGS

The accompanying drawings, which are incorporated in and constitute a part of this specification, exemplify various embodiments, and together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 shows a schematic functional block diagram of a consumables and cosmetic substance industry;

FIG. 2 shows a graph representing a value of a consumables and cosmetic substance which changes according to a change of dispense for the consumables and cosmetic substance;

FIG. 3 shows a schematic functional block diagram of a consumer information module 600;

FIG. 4 shows a schematic functional block diagram of a consumer information module 600;

FIG. 5 shows a schematic functional block diagram of a consumer information module 600;

FIG. 6 shows a schematic functional block diagram of a consumer information module 600;

FIG. 7 shows a schematic functional block diagram of a consumer information module 600;

FIG. 8 shows a schematic functional block diagram of a consumer information module 600;

FIG. 9 shows a functional block diagram of a smartphone according to an embodiment;

FIG. 10 shows a functional block diagram of a smartphone according to an embodiment;

FIG. 11 shows a functional block diagram of a smartphone according to an embodiment;

FIGS. 12a and 12 b show formats by which a ΔE, and related residual and initial efficacy values, may be expressed;

FIG. 13 shows a graph representing a value of a consumables and cosmetic substance which changes according to multiple changes of dispense for the consumables and cosmetic substance;

FIG. 14 shows a graph representing a value of a consumables and cosmetic substance which changes according to multiple changes of dispense for the consumables and cosmetic substance.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

The following discussion provides a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “controller,” “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

In some instances, the interconnection between modules is the internet, allowing the modules (with, for example, WiFi capability) to access web content offered through various web servers. The network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

The modules in the systems can be understood to be integrated in some instances and in particular embodiments, only particular modules may be interconnected.

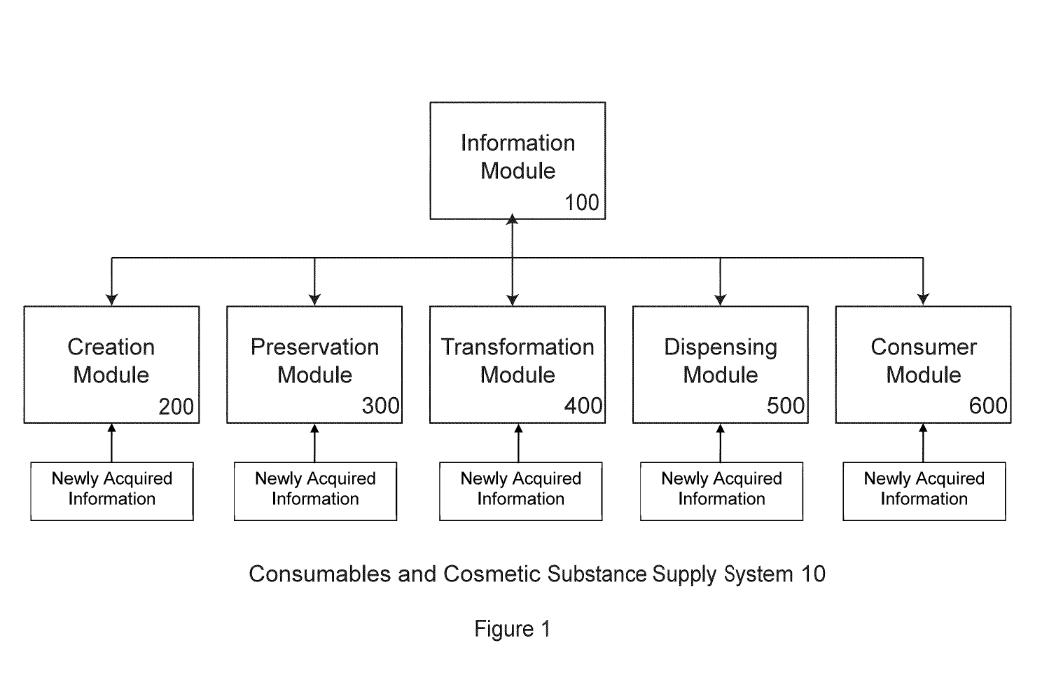

FIG. 1 shows the components of a consumables and cosmetic substance industry 10. It should be understood that this could be the consumables and cosmetic substance ecosystem for human consumption, but could also be the consumables and cosmetic substance industry for animal consumption, such as the veterinary medicine and animal grooming industries. A goal of the present invention for the consumables and cosmetic substance industry 10 is to create, preserve, transform and trace the change in efficacy values of consumables and cosmetic substances, collectively and individually also referred to herein as ΔE, through their creation, preservation, transformation, local storage, dispensing, and consumption. While the consumables and cosmetic substance industry 10 can be composed of many companies or businesses, it can also be integrated into combinations of business serving many roles, or can be one business or even individual. Since ΔE is a measure of the change in an efficacy value of a corresponding consumables and cosmetic substance, knowledge of a prior efficacy value (also referred to as prior efficacy state) of a consumables and cosmetic substance and the ΔE value will provide knowledge of the residual efficacy value (also referred to as current efficacy value or current efficacy state).

Module 200 is the creation module. This can be a system, organization, or individual which creates and/or originates consumables and cosmetic substances. Examples of this module include, but are not limited to, a farm that grows Aloe vera from which cosmetic products are made; a ranch that raises pigs from which porcine derived Insulin medicaments are made; an aquaculture farm that grows salmon from which Omega oil supplements are derived; a factory that synthesizes chemical compounds; a collector of wild Gen sing root; and so forth.

Preservation module 300, described in more detail in co-pending U.S. patent application Ser. No. ______ (attorney docket number 067465-109) filed herewith, titled “Preservation System for Consumables and Cosmetic Substances,” and incorporated by reference herein in its entirety, is a preservation system for storing, preserving and protecting the consumables and cosmetic substances created by creation module 200, or transformed by the transformation module 400. Once the consumables and cosmetic substance has been created or transformed, generally, it will need to be packaged in some manner for its transition to other modules in the consumables and cosmetic substances industry 10. While preservation module 300 is shown in a particular position in the consumables and cosmetic substance industry 10, following the creation module 200, it should be understood that the preservation module 300 actually can be placed anywhere consumables and cosmetic substances need to be stored and preserved during their transition from creation to consumption. It is understood that a consumables and cosmetic substance may experience more than one preservation event, and that such preservation events may even be considered to include the local storage of the consumables and cosmetic substance, such as in a local storage environment, a local storage container, or a dispenser prior to consumption.

Transformation module 400 is a consumables and cosmetic substance processing system, such as a manufacturer who processes raw materials such as raw vitamin compounds and carriers into multi vitamin tablets. Transformation module 400 could also be an Aloe vera extract concentrate manufacturer who receives raw components, or ingredients, also referred to herein as component consumables and cosmetic substances, from preservation module 300 (for example Aloe vera leafs in a sealed, temperature controlled container) and processes them into an Aloe vera extract concentrate. While transformation module 400 is depicted as one module, it will be understood that consumables and cosmetic substances may be transformed by a number of transformation modules 400 on their path to consumption.

Dispensing module 500 is a module for dispensing consumables and cosmetic substances immediately before consumption. Dispensing module 500 may comprise, but is not limited to, a volumetric-based dispensing system, a weight-based dispensing machine, a counting device, a controlled storage environment, a storage container tracking storage dispenses such as temperature, an individual such as a doctor, pharmacist, nurse, patient, etc. It may also be systems used by commercial establishments to prepare consumables and cosmetic substance for consumers, such as equipment used by a hospital or a compounding pharmacy, or other devices located at businesses which provide consumables and cosmetic substances to consumers. Such consumables and cosmetic substances could be for consumption at the business or for the consumer to take out from the business. Dispensing module 500 can also be any combination of these systems, machines, devices, equipment, or individuals used to dispense consumables and cosmetic substances for consumption by consumers.

Consumer module 600 collects information from the living entity which consumes the consumables and cosmetic substance which has passed through the various modules from creation to consumption. The consumer can be a human being, but could also be an animal, such as pets, zoo animals and livestock, which may themselves comprise consumables and cosmetic substances or nutritional substances for other consumption chains. Consumers could also be plant life which consumes consumables and cosmetic substances to grow, such as plants that are provided with chemical fertilizers or insecticides.

Information module 100 receives and transmits information regarding a consumables and cosmetic substance between each of the modules in the consumables and cosmetic substance industry 10 including, the creation module 200, the preservation module 300, the transformation module 400, the dispensing module 500, and the consumer module 600. The consumables and cosmetic substance information module 100 can be an interconnecting information transmission system which allows the transmission of information between various modules. Information module 100 contains a database, also referred to herein as a dynamic efficacy value database, where information regarding the consumables and cosmetic substance resides, particularly ΔE information for the consumables and cosmetic substance. Information module 100 may also contain a massive database of sensed physical attribute values for known consumables and cosmetic substances at known efficacy states, also referred to herein as a consumables and cosmetic substance attribute library, which can be utilized for determining the identity and current efficacy state of a consumables and cosmetic substance. Information module 100 can be connected to the other modules by a variety of communication systems, such as paper, computer networks, the internet and telecommunication systems, such as wireless telecommunication systems. In a system capable of receiving and processing real time consumer feedback and updates regarding changes in an efficacy value of a corresponding consumables and cosmetic substance, or ΔE, consumers can even play a role in updating the dynamic efficacy value database with observed or measured information about the consumables and cosmetic substances they have purchased and/or dispensed for consumption and/or consumed, so that the information is available and useful to determine a corresponding ΔE, and may further be available to others in the consumables and cosmetic substance supply system.

In an embodiment of the present invention, such consumer feedback and updates related to ΔE information are provided during the local storage of a consumables and cosmetic substance. In a preferred embodiment, such consumer feedback and updates related to ΔE information are obtained through, or provided by, local storage environments, local storage containers, local storage coupons, and dispensing appliances are useful in determining the ΔE and corresponding residual efficacy value of the consumables and cosmetic substance.

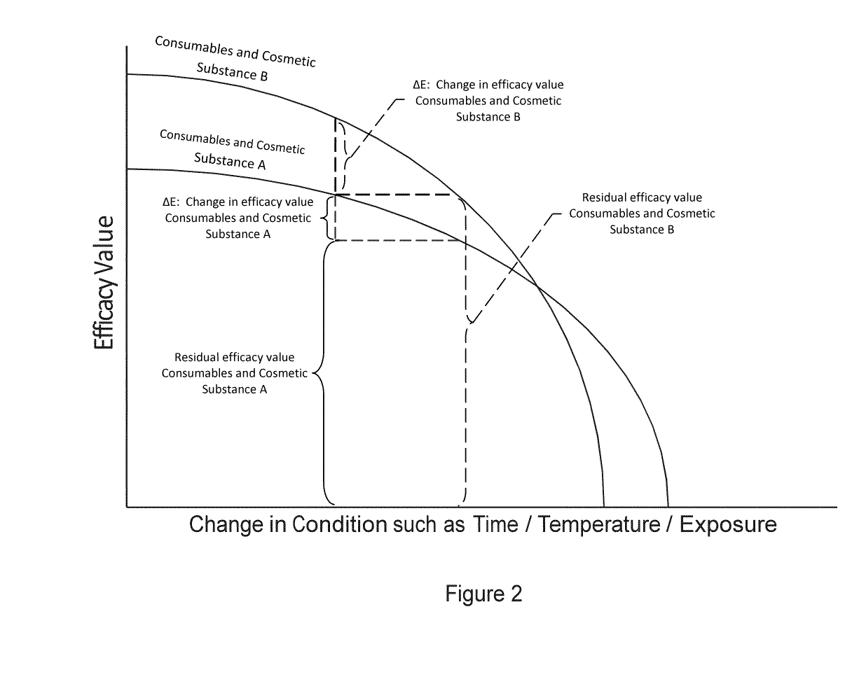

FIG. 2 is a graph showing the function of how an efficacy value of a consumables and cosmetic substance varies over the change in a dispense of the consumables and cosmetic substance. Plotted on the vertical axis of this graph can be the efficacy value of a corresponding consumables and cosmetic substance. Plotted on the horizontal axis can be the change in dispense of the consumables and cosmetic substance over a variable such as time, temperature, location, and/or exposure to environmental dispenses. This exposure to environmental dispenses can include: exposure to air, including the air pressure and partial pressures of oxygen, carbon dioxide, water, or ozone; airborne chemicals, pollutants, allergens, dust, smoke, carcinogens, radioactive isotopes, or combustion byproducts; exposure to moisture; exposure to energy such as mechanical impact, mechanical vibration, irradiation, heat, or sunlight; or exposure to materials such as packaging. The function plotted as consumables and cosmetic substance A could show a ΔE for skin lotion with Aloe vera, such as the degradation of an Aloe vera based phytochemical efficacy value over time. Any point on this curve can be compared to another point to measure and/or describe the change in efficacy value, or the ΔE, of consumables and cosmetic substance A. The function plotted as consumables and cosmetic substance B, also skin lotion with Aloe vera, shows the degradation in the same efficacy value, or the ΔE, of an Aloe vera based phytochemical efficacy value over time. Consumables and cosmetic substance B starts out with a higher efficacy value than consumables and cosmetic substance A, but degrades over time more quickly than consumables and cosmetic substance A.

In this example, where consumables and cosmetic substance A and consumables and cosmetic substance B are skin lotion with Aloe vera, this ΔE information regarding the degradation profile of efficacy value for each skin lotion could be used by the consumer in the selection and/or consumption of the corresponding skin lotion. If the consumer has this information at time zero when selecting a skin lotion product for purchase, the consumer could consider when she plans to consume the skin lotion and whether that is over a short time period or a long time period. For example, if the consumer planned to consume the skin lotion prior to the point when the curve represented by consumables and cosmetic substance B crosses the curve represented by consumables and cosmetic substance A, then the consumer should choose the skin lotion represented by consumables and cosmetic substance B because it has a higher efficacy value until it crosses the curve represented by consumables and cosmetic substance A. However, if the consumer expects to consume at least some of the skin lotion at a point in time after the time when the curve represented by consumables and cosmetic substance B crosses the curve represented by consumables and cosmetic substance A, then the consumer might choose to select the skin lotion represented by consumables and cosmetic substance A, even though the skin lotion represented by consumables and cosmetic substance A has a lower efficacy value than the skin lotion represented by consumables and cosmetic substance B at an earlier time. This change to a desired efficacy value in a consumables and cosmetic substance over a change in a dispense of the consumables and cosmetic substance described in FIG. 2 can be measured and/or controlled throughout the consumables and cosmetic substance supply system 10. This example demonstrates how dynamically generated information regarding a ΔE of a consumables and cosmetic substance, in this case a change in efficacy value of skin lotion with Aloe vera, can be used to understand a rate at which that efficacy value changes or degrades; when that efficacy value expires; and a residual efficacy value of the consumables and cosmetic substance over a change in a dispense of the consumables and cosmetic substance, in this example a change in time. This ΔE information could further be used to determine a best consumption date for consumables and cosmetic substance A and B, which could be different from each other depending upon the dynamically generated information generated for each. Still further, this ΔE information can be used to adaptively dispense the skin lotion such that the dispensed efficacy content meets the consumer's needs.

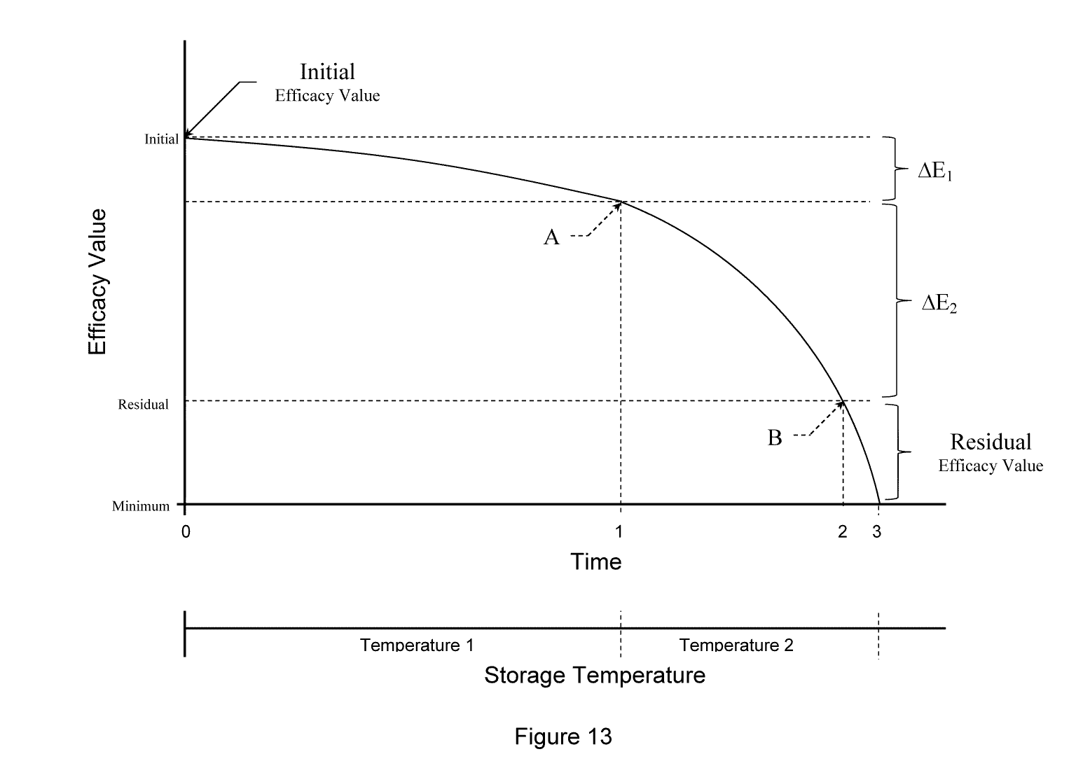

FIG. 13 is a graph showing the function of how an efficacy value of a consumables and cosmetic substance varies over a change in time and a change in a second dispense, the storage temperature of the consumables and cosmetic substance. It is understood that change in time and change in storage temperature are offered by way of example, and are in no way limiting to the types of dispense changes to which the present inventions may be applied. In this example, the change in an efficacy value of an antibiotic suspension, specifically, the change in its Penicillin concentration is shown over a period of time including its preservation at the pharmacy and a subsequent period of time including its local storage in a consumer's refrigerator. The graph shows that the antibiotic suspension is preserved at a first temperature, Temperature 1, for a first period of time indicated as 0 to 1, while at the pharmacy. The antibiotic suspension is purchased by a consumer at time 1, and subsequently stored at a second temperature, Temperature 2, for a second period of time indicated as 1 to 3, during local storage in the consumer's refrigerator, which is one example of a local storage environment as disclosed herein. It is noted that Temperature 2 is greater than Temperature 1, and accordingly the shape of the graph changes at point A when the antibiotic suspension is taken from Temperature 1 and stored at Temperature 2. As in the preservation module, the local storage environment can identify the antibiotic suspension stored within it by reading or scanning its dynamic information identifier, such as when it passes through a scanner provided in the refrigerator door, or alternatively by the consumer entering its dynamic information identifier via a consumer interface provided on the refrigerator, such as a screen, keyboard, sound system, or any known type of consumer interface. Further, the refrigerator can communicate with the consumables and cosmetic substance information module, and accordingly can determine the antibiotic suspension's ΔE prior to placement within the refrigerator, and continue to track the antibiotic suspension's ΔE while in the refrigerator. The consumer interface further enables the refrigerator to communicate to the consumer that it contains the particular bottle of antibiotic suspension, information related to ΔE, including current efficacy values of the antibiotic suspension, and when the antibiotic suspension will reach a minimum acceptable efficacy value, indicated by “Minimum” on the vertical axis of the graph. The minimum acceptable value may be automatically provided by the information module, may be determined from input provided by the consumer through the consumer interface, or may be the higher of the two values. In this case the consumer can see how the efficacy value of the antibiotic suspension has degraded prior to purchasing it, and can continue to see how the efficacy value degrades during local storage in his refrigerator after its purchase, and when it will reach its minimum acceptable efficacy value. For example, at the time indicated as 2, the consumer can determine the residual efficacy value of the antibiotic suspension, corresponding to point B and “Residual” on the vertical axis of the graph. Further, the consumer can determine that the antibiotic suspension's efficacy value will reach a minimum acceptable level at time 3, as indicated by “Minimum” on the vertical axis of the graph, thus knowing the window of time in which the antibiotic suspension will maintain an acceptable efficacy level, as indicated by time 1 to 3. Further, the refrigerator can notify the consumer through its consumer interface when the antibiotic suspension's efficacy value has reached or fallen below the minimum acceptable efficacy value.

In fact, if the consumer knows the internal temperature of his own refrigerator prior to purchasing the antibiotic suspension, he can predict the degradation of the efficacy value of the antibiotic suspension that will occur after he purchases it and locally stores it in his refrigerator, thus knowing the window of time in which it will maintain an acceptable efficacy value, as indicated by time 1 to 3. For example, the consumer may utilize an application on his smartphone to store, or even monitor, the internal temperature of his refrigerator. When he goes to the pharmacy, he could scan the antibiotic suspension's dynamic information identifier with his smartphone, and the application can communicate with the consumables and cosmetic substance information module to determine a current ΔE or corresponding residual efficacy value, and predict the ΔE of the antibiotic suspension when stored in his refrigerator. Further, the consumer may utilize such an application on his smartphone to store, or even monitor, the storage dispenses associated with various local storage environments, local storage containers, and local storage coupons. In this way, when he goes to the pharmacy or other retailers of consumables and cosmetic substances, he can scan the dynamic information identifier of a wide variety of consumables and cosmetic substances with his smartphone, and the application can communicate with the consumables and cosmetic substance information module to determine a current ΔE or corresponding residual efficacy value, and predict the ΔE of the consumables and cosmetic substance when stored in proximity to the corresponding local storage environment, local storage container, or local storage coupon.

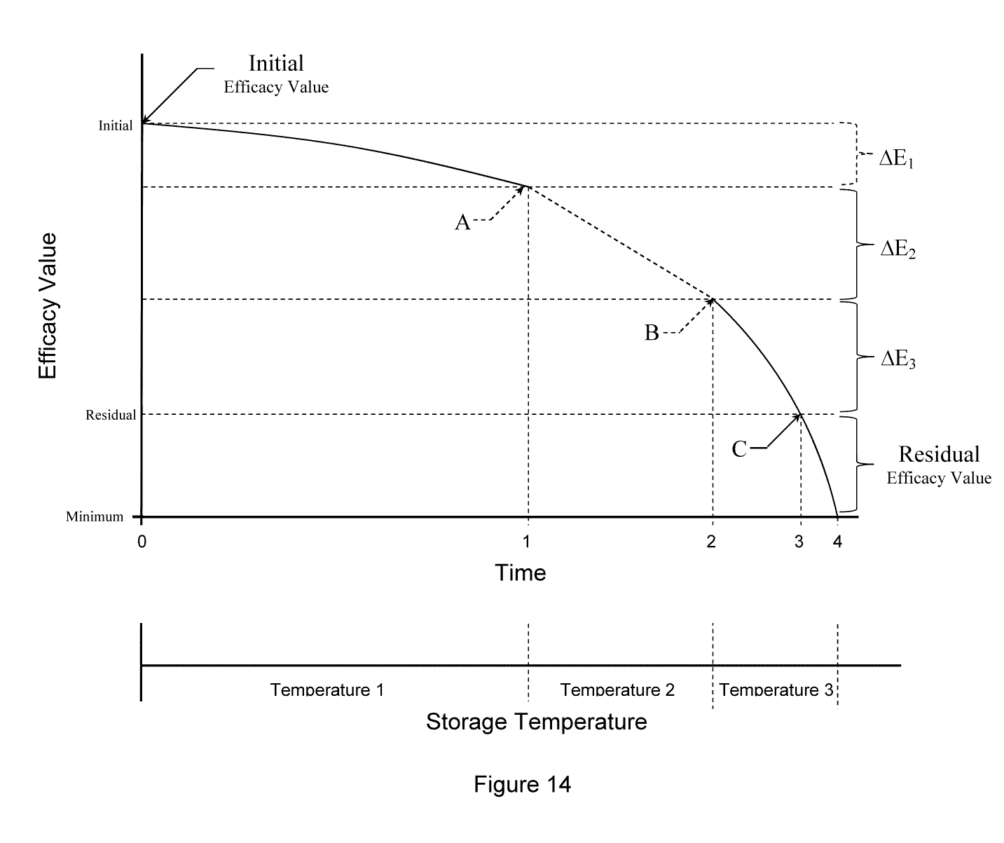

FIG. 14 is a graph showing the function of how an efficacy value of a consumables and cosmetic substance varies over a change in time and multiple changes in a second dispense, the storage temperature of the consumables and cosmetic substance. It is understood that change in time and change in storage temperature are offered by way of example, and are in no way limiting to the types on dispense changes to which the present inventions may be applied. In this example, the change in an efficacy value of an antibiotic suspension, specifically, the change in its Penicillin concentration is shown over a period of time including its preservation at the pharmacy, a subsequent period of time including its local storage in a consumer's refrigerator (which is one example of a local storage environment as disclosed herein), and further subsequent storage in the consumer's picnic cooler along with a local storage coupon (which is one example of a traditional local storage environment provided with a local storage coupon as disclosed herein). The graph shows that the antibiotic suspension is preserved at a first temperature, Temperature 1, for a first period of time indicated as 0 to 1, while at the pharmacy. The antibiotic suspension is purchased by a consumer at time 1, and subsequently stored at a second temperature, Temperature 2, for a second period of time indicated as 1 to 2, during local storage in the consumer's refrigerator. It is noted that Temperature 2 is greater than Temperature 1, and accordingly the shape of the graph changes at point A when the antibiotic suspension is taken from Temperature 1 and stored at Temperature 2. As in the preservation module, the local storage environment can identify the antibiotic suspension stored within it by reading or scanning its dynamic information identifier, such as when it passes by a scanner provided in the refrigerator door, or alternatively by the consumer entering its dynamic information identifier via a consumer interface provided on the refrigerator, such as a screen, keyboard, sound system, or any known type of consumer interface. Further, the refrigerator can communicate with the consumables and cosmetic substance information module, and accordingly can determine the antibiotic suspension's ΔE, and corresponding residual efficacy value, prior to or upon placement within the refrigerator, and continue to track the antibiotic suspension's ΔE while in the refrigerator. The consumer interface further enables the refrigerator to communicate to the consumer that it contains the particular bottle of antibiotic suspension, information related to its ΔE, including the corresponding residual efficacy value of the antibiotic suspension while stored in the refrigerator. At time 2, the antibiotic suspension is taken from the refrigerator and placed inside the consumer's traditional picnic cooler, along with a local storage coupon, where it is stored at Temperature 3, for a period of time indicated as 2 to 4. It is noted that Temperature 3 is greater than Temperature 2, and accordingly the shape of the graph changes at point B when the antibiotic suspension is taken from Temperature 2 and stored at Temperature 3. The local storage coupon can identify the antibiotic suspension stored within the picnic cooler and in its proximity by reading or scanning its dynamic information identifier (or alternatively by the consumer entering the dynamic information identifier via a consumer interface communicating with the local storage coupon), can communicate with the consumables and cosmetic substance information module, and accordingly can determine the antibiotic suspension's ΔE and corresponding residual efficacy value prior to placement within the cooler, and continue to track the antibiotic suspension's ΔE while in the cooler. The coupon may be provided with a consumer interface, such as a screen, keyboard, sound system, or any known consumer interface, or alternatively, an application on the consumer's smartphone can enable the coupon to communicate with the smartphone such that the smartphone acts as the consumer interface. The consumer interface enables the coupon to communicate to the consumer that the cooler contains the particular bottle of antibiotic suspension, information related to ΔE, including a current residual efficacy value of the antibiotic suspension while stored in the picnic cooler, and when the antibiotic suspension will reach a minimum acceptable efficacy value, indicated by “Minimum” on the vertical axis of the graph. The minimum acceptable efficacy value may be automatically provided by the information module, may be determined from input provided by the consumer through the consumer interface, or may be the higher of the two values. In this case the consumer can see how the efficacy value of the antibiotic suspension has degraded prior to placing it in the picnic cooler along with the local storage coupon, and can continue to see how the efficacy value degrades during local storage in the picnic cooler, and when it will reach its minimum acceptable efficacy value. For example, at the time indicated as 3, the consumer can determine the residual efficacy value of the antibiotic suspension, corresponding to point C and “Residual” on the vertical axis of the graph. Further, the consumer can determine the antibiotic suspension's efficacy value will reach a minimum acceptable level at time 4, as indicated by “Minimum” on the vertical axis of the graph, thus knowing the window of time in which the antibiotic suspension in the picnic cooler will maintain an acceptable efficacy value, as indicated by time 2 to 4. Further, the local storage coupon can notify the consumer through the consumer interface when the antibiotic suspension's efficacy value has reached or fallen below the minimum acceptable efficacy value.

It is understood that local storage environments can comprise any local storage environment for a consumables and cosmetic substance provided with the features enabling it to identify a dynamic information identifier on the consumables and cosmetic substance, track one or more dispenses related to a ΔE of the consumables and cosmetic substance, communicate with the consumables and cosmetic substance information module, determine a current ΔE and corresponding residual efficacy value, track and predict the ΔE of the consumables and cosmetic substance while stored therein, and communicate information related to the ΔE to a consumer. Examples of such local storage environments include, but are not limited to: a pantry capable of identifying a dynamic information identifier on bottled liquid medicines and tracking one or more dispenses related to a ΔE of the bottled liquid medicines, such as time and storage temperature; a shelf capable of identifying a dynamic information identifier on a container of dry vitamin tablets and tracking one or more dispenses related to a ΔE of the dry vitamin tablets, such as time and storage humidity; a refrigerator bin capable of identifying a dynamic information identifier on a bottle of liquid medicine and tracking one or more dispenses related to a ΔE of the liquid medicine, such as time, storage temperature, and storage humidity; a drawer capable of identifying a dynamic information identifier on vials of injectable medicaments and tracking one or more dispenses related to a ΔE of the injectable medicaments, such as time, storage temperature, and exposure to light; a medicine cabinet capable of identifying a dynamic information identifier on medicaments and tracking one or more dispenses related to a ΔE of the medicaments, such as time, storage temperature, storage humidity, and exposure to light. These local storage environments may be provided with a consumer interface, such as a screen, keyboard, sound system, or any known consumer interface. A consumer interface provided with, or communicating with, the local storage environment enables the local storage environment to communicate to the consumer that it contains a particular consumables and cosmetic substance, information related to its ΔE, including current residual efficacy values, while stored in the local storage environment.

It is understood that local storage containers as disclosed herein can comprise any local storage container for a consumables and cosmetic substance provided with features enabling it to identify a dynamic information identifier on the consumables and cosmetic substance, track one or more dispenses related to a ΔE of the consumables and cosmetic substance, communicate with the consumables and cosmetic substance information module, determine a current ΔE and corresponding residual efficacy value, track and predict the ΔE of the consumables and cosmetic substance while stored therein, and communicate information related to the ΔE to a consumer. Examples of such local storage containers include, but are not limited to: a plastic, sealable container capable of identifying a dynamic information identifier on consumables and cosmetic substances provided in the form of dry goods and tracking one or more dispenses related to a ΔE of the corresponding consumables and cosmetic substances, such as time and storage humidity; a tray capable of identifying a dynamic information identifier on a bottle of liquid soap and tracking one or more dispenses related to a ΔE of the liquid soap, such as time, storage temperature, and exposure to light; a resealable bag capable of identifying a dynamic information identifier on injection syringes pre-filled with lyophilized medicament and tracking one or more dispenses related to a ΔE of the lyophilized medicament, such as time, storage temperature, and storage humidity; a purse capable of identifying a dynamic information identifier associated with a medicament pill and tracking one or more dispenses related to a ΔE of the medicament pill, such as time, storage temperature, storage humidity, and exposure to light; a picnic cooler capable of identifying a dynamic information identifier on antibiotic suspension and tracking one or more dispenses related to a ΔE of the antibiotic suspension, such as time and storage temperature. A consumer interface provided with, or communicating with, the local storage container enables the local storage container to communicate to the consumer that it contains a particular consumables and cosmetic substance, information related to its ΔE, including current residual efficacy values, while stored in the local storage container.

It is understood that local storage coupons according to the present invention can comprise any form of tag, badge, transponder, label, or any other device, individually and collectively referred to herein as a coupon, placed in proximity to a traditional local storage environment or traditional local storage container, and capable of identifying a dynamic information identifier on a consumables and cosmetic substance stored in the traditional local storage environment or traditional local storage container, tracking one or more dispenses related to a ΔE of the consumables and cosmetic substance, communicating with the consumables and cosmetic substance information module, determining a current ΔE and corresponding residual efficacy value, tracking and predicting the ΔE of the consumables and cosmetic substance stored in the corresponding local storage environment or traditional local storage container, and communicating information related to the ΔE to a consumer. Examples of such local storage coupons include, but are not limited to: a coupon placed in a plastic container with consumables and cosmetic substance provided in the form of dry goods, wherein the coupon is capable of identifying a dynamic information identifier on or associated with the consumables and cosmetic substance and tracking one or more dispenses related to a ΔE of the consumables and cosmetic substance, such as time and storage humidity; a coupon placed on a tray for holding toiletries, wherein the coupon is capable of identifying a dynamic information identifier on the toiletries and tracking one or more dispenses related to a ΔE of the toiletries, such as time, storage temperature, and exposure to light; a coupon placed within a resealable freezer bag, wherein the coupon is capable of identifying a dynamic information identifier on bottle of pain killers placed within the resealable freezer bag and tracking one or more dispenses related to a ΔE of the bottle of pain killers, such as time, storage temperature, and storage humidity; a coupon placed within a purse, wherein the coupon is capable of identifying a dynamic information identifier on a medicament package placed within the purse and tracking one or more dispenses related to a ΔE of the corresponding medicament, such as time, storage temperature, storage humidity, and exposure to light; a coupon attached to the inner surface of a picnic cooler, wherein the coupon is capable of identifying a dynamic information identifier on antibiotic suspension stored in the cooler and tracking one or more dispenses related to a ΔE of the antibiotic suspension, such as time and storage temperature; a coupon hung in a pantry, wherein the coupon is capable of identifying a dynamic information identifier on bottled liquid soap and tracking one or more dispenses related to a ΔE of the bottled liquid soap, such as time and storage temperature; a coupon attached to a shelf, wherein the coupon is capable of identifying a dynamic information identifier on make-up and tracking one or more dispenses related to a ΔE of the make-up, such as time and storage humidity; a coupon attached to an inner surface of a refrigerator bin, wherein the coupon is capable of identifying a dynamic information identifier on a syringe of probiotics and tracking one or more dispenses related to a ΔE of the probiotics, such as time, storage temperature, and storage humidity; a coupon placed within a drawer, wherein the coupon is capable of identifying a dynamic information identifier on vials of lyophilized medicament and tracking one or more dispenses related to a ΔE of the lyophilized medicament, such as time, storage temperature, and exposure to light; a coupon attached to the inner surface of a medicine cabinet, wherein the coupon is capable of identifying a dynamic information identifier on packaged medicaments and tracking one or more dispenses related to a ΔE of the packaged medicaments, such as time, storage temperature, storage humidity, and exposure to light.

In FIG. 1, Creation module 200 can dynamically encode consumables and cosmetic substances to enable the tracking of changes in efficacy value of the consumables and cosmetic substance, or ΔE. This dynamic encoding, also referred to herein as a dynamic information identifier, can replace and/or complement existing consumables and cosmetic substance marking systems such as barcodes, labels, and/or ink markings. This dynamic encoding, or dynamic information identifier, can be used to make consumables and cosmetic substance information from creation module 200 available to information module 100 for use by preservation module 300, transformation module 400, dispensing module 500, and/or consumption module 600, which includes the ultimate consumer of the consumables and cosmetic substance. One method of marking the consumables and cosmetic substance with a dynamic information identifier by creation module 200, or any other module in consumables and cosmetic substance supply system 10, could include an electronic tagging system, such as the tagging system manufactured by Kovio of San Jose, Calif., USA. Such thin film chips can be used not only for tracking consumables and cosmetic substances, but can include components to measure attributes of consumables and cosmetic substances, and record and transmit such information. Such information may be readable by a reader including a satellite-based system. Such a satellite-based consumables and cosmetic substance information tracking system could comprise a network of satellites with coverage of some or all the surface of the earth, so as to allow the dynamic efficacy value database of information module 100 real time, or near real time updates about a ΔE of a particular consumables and cosmetic substance.

A method of marking the consumables and cosmetic substance with a dynamic information identifier, by creation module 200, or any other module in consumables and cosmetic substance supply system 10, could include providing an actual printed alphanumeric code on the consumables and cosmetic substance that can be scanned, such as by a smartphone with a camera running an application for reading alphanumeric characters, or might be manually entered by any member of the consumables and cosmetic substance supply system. Another method of marking the consumables and cosmetic substance with a dynamic information identifier by creation module 200 or any other module in efficacy supply system 10, could include providing the consumables and cosmetic substance with a barcode allowing retrieval of the dynamic information identifier using an appropriate barcode scanner, such as a smartphone with a camera running an application for reading barcode. Another method of marking the consumables and cosmetic substance with a dynamic information identifier, by creation module 200, or any other module in efficacy supply system 10, could include providing the consumables and cosmetic substance with an RF tag allowing retrieval of the dynamic information identifier using an appropriate RF scanner. Still another method of marking the consumables and cosmetic substance with a dynamic information identifier, by creation module 200, or any other module in efficacy supply system 10, could include providing the consumables and cosmetic substance with a printed QR code (Quick Response Code) allowing retrieval of the dynamic information identifier using an appropriate QR code scanner, such as a smartphone with a camera running an application for reading QR code.

QR codes offer several advantages over other marking methodologies. QR codes are currently utilized by many consumers, using their smartphones, to hardlink to a target website through a URL (Uniform Resource Locator) stored on the QR code. This type of hardlinking is also known as object hyperlinking QR codes are simple to generate, inexpensive printed labels with sufficient storage capacity to store a dynamic information identifier and to store a URL to information module 100. QR codes can be provided on consumables and cosmetic substances, by any member of the consumables and cosmetic substance supply system, to include the consumables and cosmetic substance dynamic information identifier and a URL to hardlink any member of the consumables and cosmetic substance supply system to information module 100. Using a smart phone any member of the consumables and cosmetic substance supply system can scan a consumables and cosmetic substance and automatically be linked to information module 100 to retrieve creation, origin, and ΔE information regarding the scanned consumables and cosmetic substance. QR codes are a cost effective, readily adopted, provider-friendly, and user-friendly way to mark consumables and cosmetic substances.

Preservation module 300 includes packers and shippers of consumables and cosmetic substances. The tracking of changes in efficacy values, or ΔE, during the preservation period within preservation module 300 allows for dynamic expiration dates for consumables and cosmetic substances. For example, expiration dates for medicament products are currently based generally only on time using assumptions regarding minimal dispenses at which the corresponding medicament products are maintained. This extrapolated expiration date is based on a worst-case scenario for when the product becomes unsafe to consume during the preservation period, or when an efficacy value drops below an acceptable minimum value. In reality, the degradation of medicament products may be significantly less than this worst-case. If preservation module 300 could measure or derive the actual degradation information such as ΔE, an actual expiration date, referred to herein as a dynamic expiration date, can be determined dynamically, and could be significantly later in time than an extrapolated expiration date. This would allow the consumables and cosmetic substance supply system to dispose of fewer products due to expiration dates. This ability to dynamically generate expiration dates for consumables and cosmetic substances is of particular significance when consumables and cosmetic substances contain few or no preservatives, which is often the case.

It should be noted that a dynamic expiration date need not be indicated numerically (i.e., as a numerical date) but could be indicated symbolically as by the use of colors—such as green, yellow and red employed on semaphores—or other designations. In those instances, the dynamic expiration date would not be interpreted literally but, rather, as a dynamically-determined advisory date. In practice a dynamic expiration date will be provided for at least one component of a single or multi-component consumables and cosmetic substance. For multi-component consumables and cosmetic substances, the dynamic expiration date could be interpreted as a “best” date for consumption for particular components.

By law, in many localities, consumables and cosmetic substance processors such as those in transformation module 400 are required to provide consumables and cosmetic substance information regarding their products. Often, this information takes the form of an ingredient table applied to the packaging of the consumables and cosmetic substance. Currently, the information in this ingredient table is based on averages or minimums for their typical product. Using the consumables and cosmetic substance information from information module 100 provided by creation module 200, preservation module 300, and/or information from the transformation of the consumables and cosmetic substance by transformation module 400, and consumer feedback and updates related to ΔE, preferably obtained through or provided by local storage environments, local storage containers, and local storage coupons, the consumables and cosmetic substance processor could include a dynamically generated efficacy value table, also referred to herein as a dynamic efficacy value table, for the actual consumables and cosmetic substance being supplied to consumers and further being locally stored by consumers. The information in such a dynamic efficacy value table could be used by dispensing module 500 for adaptively dispensing the consumables and cosmetic substance, and/or used by consumption module 600, so as to allow the ultimate consumer the ability to select the most desirable consumables and cosmetic substance which meets their needs, and/or to track information regarding consumables and cosmetic substances consumed.

Information about changes in efficacy values of consumables and cosmetic substances, or ΔE, is particularly useful in the dispensing module 500, as it allows knowing, or estimating, a ΔE prior to dispensing, and the corresponding pre-dispensing state of the efficacy values of the consumables and cosmetic substance, including the changes in efficacy values occurring during local storage of the consumables and cosmetic substance, and further enables the determination of dispensing parameters responsive to the ΔE occurring prior to dispensing. The dispensing module 500 can thereby provide adaptive dispensing parameters, such as by modifying existing or baseline dispensing parameters, to deliver a desired amount of efficacy content. The pre-dispensing ΔE and corresponding efficacy value of a consumables and cosmetic substance is not tracked or provided to the consumer by existing local storage environments, local storage containers, dispensing devices or individuals. However, using information provided by information module 100 from creation module 200, preservation module 300, transformation module 400, and consumer feedback and updates related to ΔE, preferably obtained through or provided by local storage environments, local storage containers, and local storage coupons, and/or information measured or generated by dispensing module 500, and/or consumer input regarding efficacy value or a desired amount of efficacy content provided through the dispensing module 500, dispensing module 500 can provide the consumer with the actual, and/or estimated change in efficacy values of the consumables and cosmetic substance, or ΔE, prior to dispensing, and can further provide adaptive dispensing parameters responsive to the ΔE and the consumer's input to deliver a desired amount of efficacy content.

An important benefit provided by local storage environments and local storage containers disclosed herein is that consumer feedback and updates related to ΔE, such as observed or measured information of, or related to, a ΔE during local storage of the consumables and cosmetic substance is obtained through, or provided by, the local storage environments, containers, and coupons. In this way consumer feedback and updates related to a ΔE during local storage of a consumables and cosmetic substance can play a role in updating the dynamic efficacy value information about the consumables and cosmetic substances consumers have purchased and placed in local storage, such as through modification of ΔE. Such information regarding the change to efficacy value of the consumables and cosmetic substance, or ΔE, could be provided not only to a consumer through the consumption module 600 and dispensing module 500, but could also be provided to information module 100 for use by creation module 200, preservation module 300, transformation module 400, so as to track, and possibly improve consumables and cosmetic substances throughout the entire consumables and cosmetic substance supply system 10.

The information regarding consumables and cosmetic substances provided by information module 100 to consumption module 600 can replace or complement existing traditional information sources such as, but not limited to, traditional labeling, consumables and cosmetic substance websites like www.webmd.com, www.doctoroz.com, and consumables and cosmetic substance manufacturer's websites. Through the use of specific information regarding a consumables and cosmetic substance from information module 100, consumers can use consumption module 600 to select consumables and cosmetic substances according to ΔE information and residual efficacy values. This will further allow consumers to make informed decisions regarding consumables and cosmetic substance additives, preservatives, origins, traceability, and other consumables and cosmetic substance attributes that may also be tracked through the information module 100. This information can be provided by consumption module 600 through personal computers, laptop computers, tablet computers, and/or smartphones. Software running on these devices can include dedicated computer programs, modules within general programs, and/or smartphone apps. An example of an analogous smartphone app for consumables and cosmetic substances is the iOS ShopNoGMO from the Institute for Responsible Technology. This iPhone app allows consumers access to information regarding non-genetically modified organisms they may select. Additionally, consumption module 600 may provide information for the consumer to operate dispensing module 500 with adaptive dispensing parameters, wherein the adaptive dispensing parameters are responsive to a ΔE or corresponding residual efficacy value of the consumables and cosmetic substance being dispensed and may further be responsive to the consumer's input related to the ΔE, the corresponding efficacy value, or the corresponding amount of efficacy content to be dispensed. In this way, the amount of efficacy content in the dispensed consumables and cosmetic substance can be optimized or maintained, according to, but not limited to: a target amount based on the consumer's input regarding his needs or preference; a target amount established by the provider of the consumables and cosmetic substance, such as the transformer; a target amount established by a dispenser of the consumables and cosmetic substance, such as a service provider; or a target amount equal to a predetermined amount of efficacy content recommended by the labeling or product information provided with the consumables and cosmetic substance.

Through the use of consumables and cosmetic substance information available from information module 100, the consumables and cosmetic substance supply system 10 can track efficacy values of consumables and cosmetic substances. Using this information, consumables and cosmetic substances travelling through consumables and cosmetic substance supply system 10 can be dynamically valued and priced according to efficacy values. For example, consumables and cosmetic substances with longer dynamic expiration dates (longer shelf life) may be more highly valued than consumables and cosmetic substances with shorter expiration dates. Additionally, consumables and cosmetic substances with higher efficacy values may be more highly valued, not just by the consumer, but also by each entity within consumables and cosmetic substance supply system 10. This is because each entity will want to start with a consumables and cosmetic substance with higher efficacy value before it performs its function and passes the consumables and cosmetic substance along to the next entity. Therefore, both the starting efficacy values and the ΔE associated with those values are important factors in determining or estimating an actual, or residual, efficacy value of a consumables and cosmetic substance, and accordingly are important factors in establishing dynamically valued and priced consumables and cosmetic substances.

The use of local storage environments, local storage containers, and local storage coupons disclosed herein can beneficially make information related to a ΔE of a locally stored consumables and cosmetic substance available to information module 100, so that information available from information module 100 can enable a consumer, or any entity inside or outside the consumables and cosmetic substance supply system 10, to track the corresponding efficacy value of the consumables and cosmetic substance during its local storage. It is understood that such local storage includes local storage by any entity that provides or otherwise dispenses consumables and cosmetic substances for consumption by a consumer, and could include the consumer's residence, a pharmacy, a hospital, a supermarket, a vending machine, or any other known entity providing consumables and cosmetic substances for consumption.

During the period of implementation of the present inventions, there will be consumables and cosmetic substances being marketed including those benefiting from the tracking of dynamic efficacy information such as ΔE, also referred to herein as information-enabled consumables and cosmetic substances, and consumables and cosmetic substances which do not benefit from the tracking of dynamic nutritional information such as ΔE, which are not information enabled and are referred to herein as dumb consumables and cosmetic substances. Information-enabled consumables and cosmetic substances would be available in virtual internet marketplaces, as well as traditional marketplaces. Because of information provided by information-enabled consumables and cosmetic substances, entities within the consumables and cosmetic substance supply system 10, including consumers, would be able to review and select information-enabled consumables and cosmetic substances for purchase. It should be expected that, initially, the information-enabled consumables and cosmetic substances would enjoy a higher market value and price than dumb consumables and cosmetic substances. However, as information-enabled consumables and cosmetic substances become more the norm, the cost savings from less waste due to degradation of information-enabled consumables and cosmetic substances could lead to their price actually becoming less than dumb consumables and cosmetic substances.

For example, the manufacturer of a skin lotion with Aloe vera would prefer to use Aloe vera concentrate of a high efficacy value in the production of its product, the skin lotion with Aloe vera, so as to produce a premium product of high efficacy value. Depending upon the levels of the efficacy values in the skin lotion with Aloe vera, the manufacturer may be able to charge a premium price and/or differentiate its product from that of other manufacturers. When selecting the Aloe vera concentrate to be used in the skin lotion with Aloe vera, the manufacturer will seek Aloe vera concertrate of high efficacy value from preservation module 300 that meets its requirements for efficacy value. The packager/shipper of preservation module 300 would also be able to charge a premium for Aloe vera concentrate which has high efficacy values upon delivery to the manufacturer of the skin lotion, and therefore is incentivized to select Aloe vera concentrate of high efficacy value from the transformation module 400, such as a processer of Aloe vera concentrate. The concentrate processer will be able to charge a premium for Aloe vera concentrate of high efficacy value, and will select Aloe vera leafs of high efficacy value from the preservation module 300, such as a produce packager/shipper. The produce packager/shipper of preservation module 300 would also be able to charge a premium for Aloe vera leafs which have high efficacy values, and therefore is inclined to select Aloe vera leafs of high efficacy value from the grower of creation module 200, who will also be able to charge a premium for Aloe vera leafs of high efficacy value.

Further, the consumer of the skin lotion with Aloe vera may want to, or in the case of a hotel, spa, hospital, or any other regulated service provider or dispenser, may be required to, track the efficacy value of the skin lotion during its local storage. Local storage environments, local storage containers, and local storage coupons disclosed herein enable such tracking by making information related to ΔE during local storage available to information module 100 for updating the dynamic efficacy values of consumables and cosmetic substances.

The change to efficacy value for a consumables and cosmetic substance, or ΔE, tracked through consumables and cosmetic substance supply system 10 through consumables and cosmetic substance information from information module 100 can be preferably determined from measured information. However, some or all such consumables and cosmetic substance ΔE information may be derived through measurements of environmental dispenses of the consumables and cosmetic substance as it travelled through consumables and cosmetic substance supply system 10. Additionally, some or all of the consumables and cosmetic substance ΔE information can be derived from ΔE data of other consumables and cosmetic substances which have travelled through consumables and cosmetic substance supply system 10. Consumables and cosmetic substance ΔE information can also be derived from laboratory experiments performed on other consumables and cosmetic substances, which may approximate dispenses and/or processes to which the actual consumables and cosmetic substance has been exposed. Further, consumer feedback and updates regarding observed or measured changes in the efficacy value of consumables and cosmetic substances can play a role in updating ΔE information. Also, a creator, preserver, transformer, or dispenser may revise ΔE information, or information regarding other attributes of consumables and cosmetic substances they have previously created or processed, based upon newly acquired information affecting the ΔE or the other attributes.

For example, laboratory experiments can be performed on over-the-counter medicaments to determine the effect on, or change in, corresponding efficacy values, for a variety of environmental dispenses the over-the-counter medicaments may be exposed to during packaging and shipment in preservation module 300, or during local storage by a consumer or dispenser. Using this experimental data, tables and/or algorithms could be developed which would predict the level of change of efficacy values, or ΔE, for a particular over-the-counter medicament based upon information collected regarding the environmental dispenses to which the over-the-counter medicament was exposed during its time in preservation module 300 or local storage. While the ultimate goal for consumables and cosmetic substance supply system 10 would be the actual measurement of efficacy values to determine ΔE, use of derived efficacy values from experimental data to determine ΔE would allow improved logistics planning because it provides the ability to prospectively estimate changes to efficacy values, or ΔE, and because it allows more accurate tracking of changes to efficacy values, or ΔE, while technology and systems are put in place to allow actual measurement.

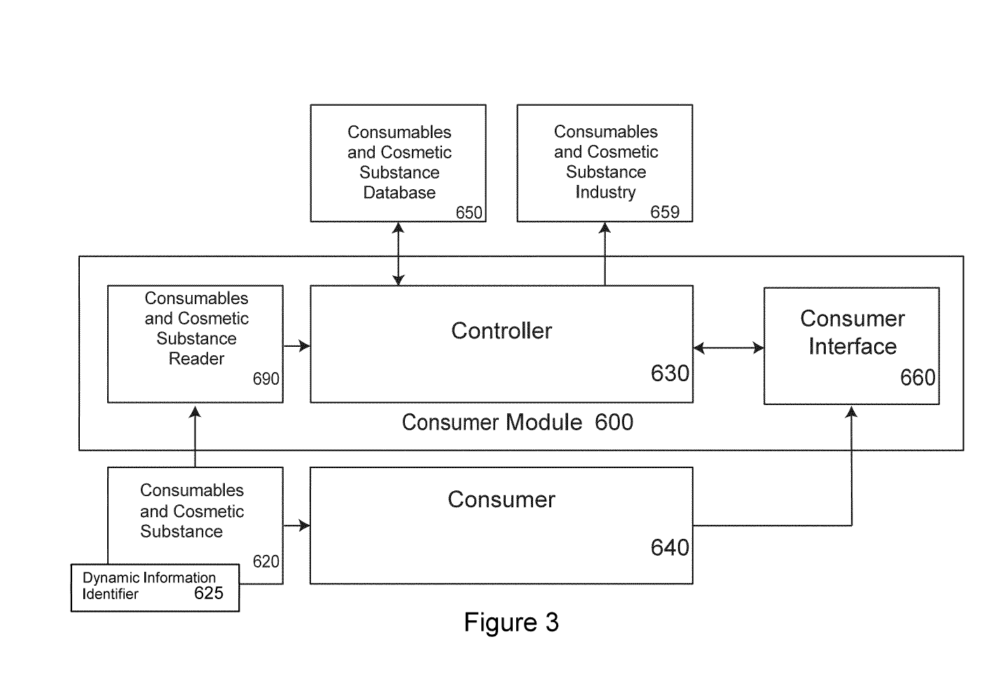

FIG. 3 shows an embodiment of consumer module 600. In a first embodiment, consumer module 600 comprises consumables and cosmetic substance reader 690, controller 630, and consumer interface 660. A consumables and cosmetic substance 620 is read by consumables and cosmetic substance reader 690 to obtain reference information regarding consumables and cosmetic substance 620 allowing retrieval of information regarding consumables and cosmetic substance 620 and provides it to controller 630. The reference information regarding the consumables and cosmetic substance may comprise a dynamic information identifier 625 provided with and/or associated with the consumables and cosmetic substance 620. Consumables and cosmetic substance reader 690 provides such reference information, the dynamic information identifier 625, to controller 630. Prior to, during, and/or following, consumption of consumables and cosmetic substance 620 consumer 640 provides information to consumer interface 660. Such information is provided by consumer interface 660 to controller 630. Controller 630 correlates the consumables and cosmetic substance information and/or the dynamic information identifier 625 and/or the consumer information and provides the correlated information to consumables and cosmetic substance industry 659. Such information may be used for improving consumables and cosmetic substance 620, creating new consumables and cosmetic substances, discontinuing consumables and cosmetic substances, and for marketing consumables and cosmetic substance 620. Other uses of such correlated consumer information will be apparent to those in the consumables and cosmetic substance industry 659. In a further embodiment described herein, consumer information may also be provided to the consumables and cosmetic substance industry 659. In an additional embodiment, such consumer provided information is related to observed or measured efficacy values of the consumables and cosmetic substance before or after dispensing, and is available for updating a dynamic efficacy value dataset within the consumables and cosmetic substance database 650 associated with the dynamic information identifier 625. In this case, the consumer contributes input to the dynamic consumables and cosmetic substance information available for the consumables and cosmetic substances they purchase and consume.

In an alternate embodiment, controller 630 references dynamic information identifier 625 for consumables and cosmetic substance 620 to consumables and cosmetic substance database 650 to determine those in consumables and cosmetic substance industry 659 who were involved in the creation, preserving, transforming, dispensing, and/or consumption of the consumables and cosmetic substance 620. Controller 630 may provide the consumer information regarding consumables and cosmetic substance 620 to those involved in the supply chain of consumables and cosmetic substance 620.

Consumer module 600 can be implemented with discreet devices. For example, consumables and cosmetic substance reader 690 could be an optical reader such as a barcode scanner or camera capable of discerning reference information, such as a dynamic information identifier. Preferably, consumables and cosmetic substance reader 690 could be an optical reader such as a QR code scanner or camera capable of discerning reference information, such as a dynamic information identifier, and capable of discerning a URL to hardlink a user to information module 100. Consumables and cosmetic substance reader 690 could also be a wireless signal reader, reading RFID labels, or near field IDs. Controller 630 can be a computer, microcontroller, personal computer, laptop computer, tablet computer, or smartphone. Consumer interface 660 can be a standalone touchpad display panel which allows interaction with the consumer, but is preferably integrated into controller 630. Consumables and cosmetic substance reader 690 may also be integrated into controller 630.

Preferably, consumer module 600 is an integrated device such as a tablet computer or smartphone. In this case, consumables and cosmetic substance reader 690 could be the camera located on the tablet or smartphone. Consumer interface 660 would be the touchscreen display of the tablet or smartphone. Finally, controller 630 would be the microprocessor in the tablet computer or smartphone. In this embodiment, the software to run consumer module 600 could be an app loaded onto the tablet or smartphone, designed to collect consumer information correlated to a known consumables and cosmetic substance 620, and if desired, to a known consumables and cosmetic substance dynamic information identifier 625.

In operation, consumer 640 would use the camera on the tablet computer or smartphone to read a barcode or QR code on consumables and cosmetic substance 620 providing the reference information or dynamic information identifier 625 for consumables and cosmetic substance 620. The tablet computer or smartphone would display an appropriate user interface so as to allow consumer 640 to provide information about her consumption of consumables and cosmetic substance 620. Controller 630 could query consumables and cosmetic substance database 650 using dynamic information identifier 625 regarding consumables and cosmetic substance 620 to determine those in the consumables and cosmetic substance industry who were involved in the supply chain for consumables and cosmetic substance 620 or to determine a current and/or post dispensing efficacy value of the consumables and cosmetic substance. Additionally, consumables and cosmetic substance database 650 could contain information on what information to collect from consumer 640 of the particular consumables and cosmetic substance 620 being referenced. The tablet computer or smartphone could then display an appropriate user interface so as to allow consumer 640 to provide information about desired, and possibly observed, efficacy values of the consumables and cosmetic substance 620.

Such information could be provided through a connection to the internet accessed through the telecommunication system in the tablet computer or smartphone. Preferably, such a telecommunications connection to consumables and cosmetic substance database 650 would be a wireless telecommunication system. The tablet computer or smartphone would then, in the same manner, provide the consumer information regarding her consumption of consumables and cosmetic substance 620 to those in consumables and cosmetic substance industry 659 involved in the supply chain of consumables and cosmetic substance 620.

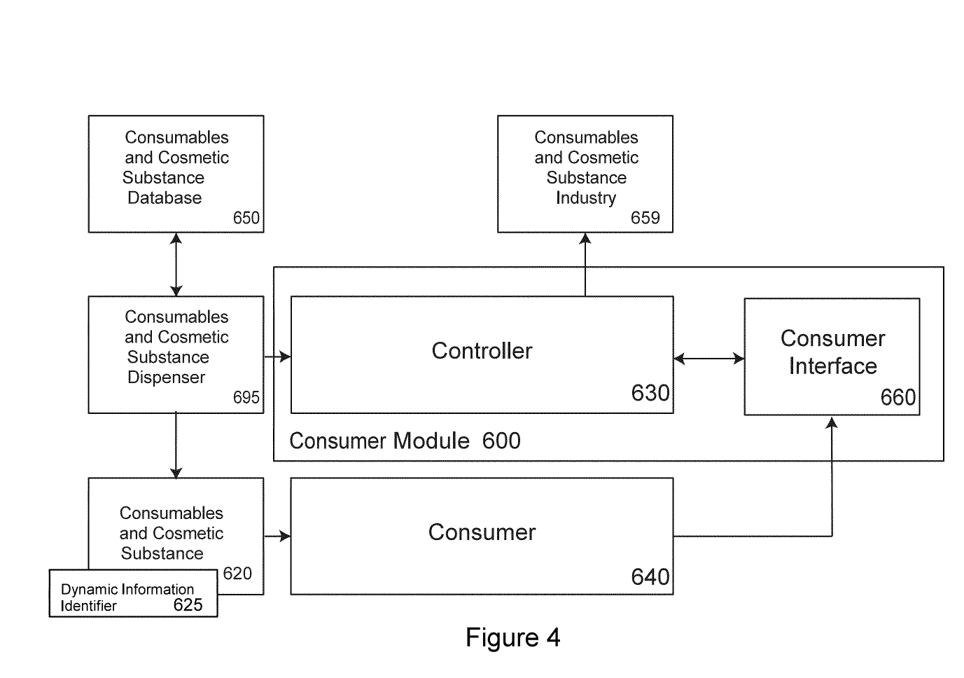

FIG. 4 shows an alternate embodiment where consumables and cosmetic substance 620 is dispensed by consumables and cosmetic substance dispenser 695. In this case, consumables and cosmetic substance dispenser 695 would already have information pertaining to consumables and cosmetic substance 620, including its dynamic information identifier 625 and information on how consumables and cosmetic substance 620 was locally stored and dispensed by dispenser 695.

In this embodiment, controller 630 receives such information regarding consumables and cosmetic substance 620 and correlates it with consumer information from consumer interface 660 and provides it to consumables and cosmetic substance industry 659.

For example, consumables and cosmetic substance dispenser 695 dispenses a skin lotion with Aloe vera. In the process of dispensing the skin lotion with Aloe vera, consumables and cosmetic substance dispenser 695 receives various information, such as by reading the dynamic information identifier 625 provided on a reference tag on the skin lotion with Aloe vera. Using the dynamic information identifier 625, consumables and cosmetic substance dispenser 695 receives, from consumables and cosmetic substance database 650, information regarding consumables and cosmetic substance 620, the skin lotion with Aloe vera. In this case, the consumables and cosmetic substance dispenser 695 is an information ready dispenser, such as an automated electric pump, that is capable of processing information enabled consumables and cosmetic substances, and it obtains from consumables and cosmetic substance database 650 efficacy information about the skin lotion with Aloe vera, such as ΔE or corresponding residual efficacy value, and may also retrieve source, origin and creation information. The dispenser adaptively dispenses a volume of skin lotion responsive to the ΔE or corresponding residual efficacy value, so as to dispense a specified amount of efficacy content. In a preferred embodiment, such adaptive dispensing parameters are responsive to the ΔE or corresponding residual efficacy value and consumer input or information, in particular, input or information related to the ΔE or corresponding residual efficacy value, or a desired efficacy content to be dispensed. The dispenser 695 also provides the information regarding the skin lotion with Aloe vera it received from consumables and cosmetic substance database 650, along with information it collected regarding the dispensing of the skin lotion with Aloe vera, to controller 630. In an embodiment, consumer module 600 is a standalone device such as a tablet computer or smartphone, the information from consumables and cosmetic substance dispenser 695 could be transferred by means of a wireless local area network or Bluetooth connection. Consumer module 600, a smartphone for example, would obtain consumer information regarding the consumption of the consumables and cosmetic substance 620, the skin lotion with Aloe vera. Such information may include consumer feedback, observations, or measurements regarding the efficacy value of the consumables and cosmetic substance before or after dispensing.

In the case of the skin lotion with Aloe vera, the consumer 640 could be asked if their skin felt oily after application, if their skin felt softer after application, and might further be asked about the ease of application, the fragrance, and so forth. Using such information and the information from the consumables and cosmetic substance database 650, consumer module 600 can provide appropriate information to those in the consumables and cosmetic substance industry 659 who were involved in the supply chain for the skin lotion with Aloe vera. Such information could even be available to other consumers of the consumables and cosmetic substance through consumables and cosmetic substance industry 659 or consumables and cosmetic substance database 650.

In another embodiment, consumer module 600 could be part of consumables and cosmetic substance dispenser 695. In this case, the dispenser would provide user interface 660 to receive consumer information regarding the consumables and cosmetic substance 620 dispensed by consumables and cosmetic substance dispenser 695. In such a case, controller 630 likely would be the same controller which operates consumables and cosmetic substance dispenser 695.

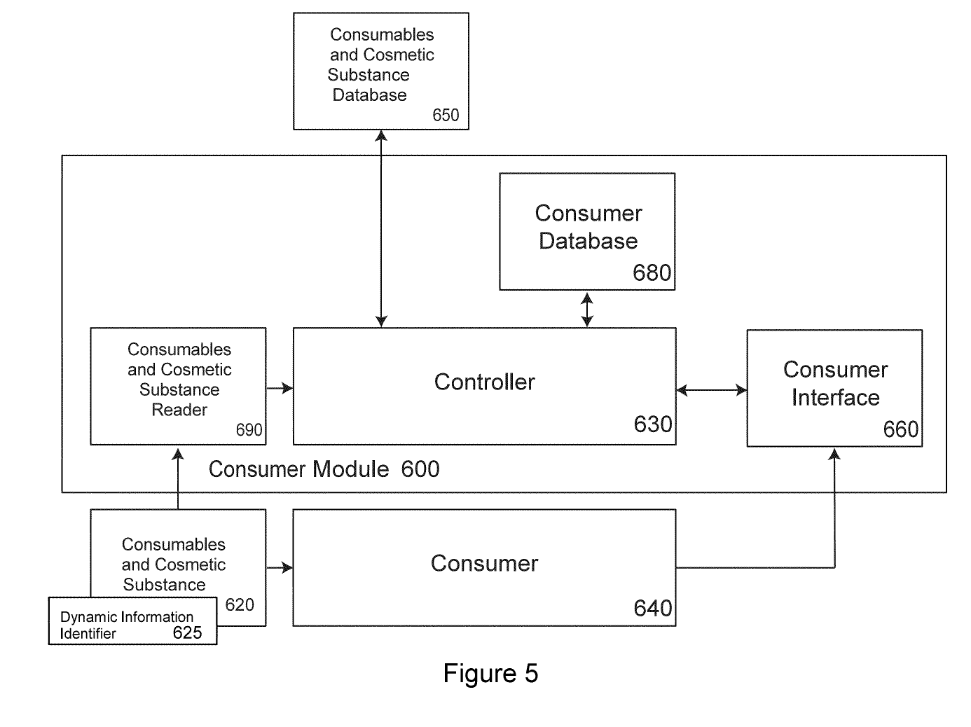

FIG. 5 shows an embodiment of consumer module 600. In a first embodiment, consumer module 600 comprises consumables and cosmetic substance reader 690, controller 630, and consumer interface 660. A consumables and cosmetic substance 620 is read by consumables and cosmetic substance reader 690 to obtain reference information regarding consumables and cosmetic substance 620 in the form of a dynamic information identifier 625. Consumables and cosmetic substance reader 690 provides the dynamic information identifier 625 to controller 630. Prior to, during, and/or following consumption of consumables and cosmetic substance 620, consumer 640 provides information to consumer interface 660. Such information is provided by consumer interface 660 to controller 630. Controller 630 correlates the consumables and cosmetic substance information and/or the dynamic information identifier and the consumer information and provides the correlated information to consumables and cosmetic substance database 650. Such information may be used for creating adaptive dispensing parameters to dispense a quantity of consumables and cosmetic substance 620 responsive to the ΔE or corresponding residual efficacy value, so as to dispense a specified amount of efficacy content, and may further be used for improving consumables and cosmetic substance 620, creating new consumables and cosmetic substances, discontinuing consumables and cosmetic substances, and for marketing consumables and cosmetic substance 620. In a preferred embodiment, such adaptive dispensing parameters are responsive to the ΔE or corresponding residual efficacy value and consumer input or information, in particular, input or information related to the ΔE or corresponding residual efficacy value, or a desired efficacy content to be dispensed. Other uses of such correlated consumer information will be apparent to those in the consumables and cosmetic substance industry 659. In a further embodiment, consumer information may also be provided to the consumables and cosmetic substance industry 659. In an additional embodiment, consumer provided information could be related to observed or measured efficacy values of the consumables and cosmetic substance before or after dispensing, and is available for updating a dynamic efficacy value dataset within the consumables and cosmetic substance database 650 associated with the dynamic information identifier 625. In this case, the consumer contributes input to the dynamic consumables and cosmetic substance information available for the consumables and cosmetic substances they purchase and consume.

In an alternate embodiment, controller 630 references dynamic information identifier 625 for consumables and cosmetic substance 620 to consumables and cosmetic substance database 650 to determine those in consumables and cosmetic substance industry who were involved in the creation, preserving, transforming, and/or dispensing of the consumables and cosmetic substance 620. Controller 630 may provide the consumer information regarding consumables and cosmetic substance 620 to those involved in the supply chain of consumables and cosmetic substance 620 or may make consumer information available to other consumers of the consumables and cosmetic substance.

Also included in consumer module 600 is consumer database 680. Consumer database 680 contains specific information regarding consumer 640. Correlated information regarding the consumption of consumables and cosmetic substance 620 could be stored for future reference in consumer database 680 and is preferably correlated with the dynamic information identifier 625. Such information could be used in collecting future consumer information. For example, if consumer 640 is very particular about a certain aspect of a consumables and cosmetic substance 620, controller 630 could ask for additional and/or more specific information from consumer 640 about the consumables and cosmetic substance 620 through consumer interface 660. As an example, consumer 640 may be very particular about the texture of skin lotion and the efficacy associated with its Aloe vera content. When consumables and cosmetic substance 620 is skin lotion with Aloe vera being considered for purchase, controller 630, in response to historical consumer 640 information in consumer database 680, could ask for additional information regarding the texture of the skin lotion and related to the efficacy values of its Aloe vera content, using consumer interface 660. In this case, the consumer contributes valuable input to the dynamic consumables and cosmetic substance information available for the consumables and cosmetic substances they purchase and consume.

Consumer module 600 can be implemented with discreet devices. For example, consumables and cosmetic substance reader 690 could be an optical reader such as a barcode scanner or camera capable of discerning reference information, such as a dynamic information identifier. Preferably, consumables and cosmetic substance reader 690 could be an optical reader such as a QR code scanner or camera capable of discerning reference information, such as a dynamic information identifier, and capable of discerning a URL to hardlink a user to consumables and cosmetic substance database 650, or to information module 100 wherein consumables and cosmetic substance database 650 may reside. Consumables and cosmetic substance reader 690 could also be a wireless signal reader, reading RFID labels, or near field IDs. Controller 630 can be a computer, microcontroller, personal computer, laptop computer, tablet computer, or smartphone. Consumer interface 660 can be a standalone touchpad display panel which allows interaction with the consumer, but is preferably integrated into controller 630. Consumables and cosmetic substance reader 690 may also be a standalone device, or integrated into controller 630.

Preferably, consumer module 600 is an integrated device such as a tablet computer or smartphone. In this case, consumables and cosmetic substance reader 690 could be the camera located on the tablet or smartphone. Consumer interface 660 would be the touchscreen display of the tablet or smartphone. Finally, controller 630 would be the microprocessor in the tablet computer or smartphone. In this embodiment, the software to run consumer module 600 could be an app loaded onto the tablet or smartphone, designed to collect consumer information correlated to a known consumables and cosmetic substance 620 and if desired, to a known consumables and cosmetic substance dynamic information identifier 625.

In operation, consumer 640 would use the camera on the tablet computer or smartphone to read a barcode or QR code on consumables and cosmetic substance 620 providing the reference information or dynamic information identifier 625 for consumables and cosmetic substance 620. The tablet computer or smartphone would display an appropriate user interface so as to allow consumer 640 to provide information about her consumption of consumables and cosmetic substance 620. Controller 630 could query consumables and cosmetic substance database 650 using dynamic information identifier 625 regarding consumables and cosmetic substance 620 to determine those in the consumables and cosmetic substance industry who were involved in the supply chain for consumables and cosmetic substance 620 or to determine a current efficacy value of the consumables and cosmetic substance. Additionally, consumables and cosmetic substance database 650 could contain information on what information to collect from consumer 640 of the particular consumables and cosmetic substance 620 being referenced. The tablet computer or smartphone could then display an appropriate user interface so as to allow consumer 640 to provide input or information, such as regarding source, origin, or creation information or efficacy values of the consumables and cosmetic substance 620.

Such information could be provided through a connection to the internet accessed through the telecommunication system in the tablet computer or smartphone. Preferably, such a telecommunications connection to consumables and cosmetic substance database 650 would be a wireless telecommunication system. The tablet computer or smartphone would then, in the same manner, provide the consumer information regarding her consumption of consumables and cosmetic substance 620 to those in consumables and cosmetic substance industry 659 involved in the supply chain of consumables and cosmetic substance 620.

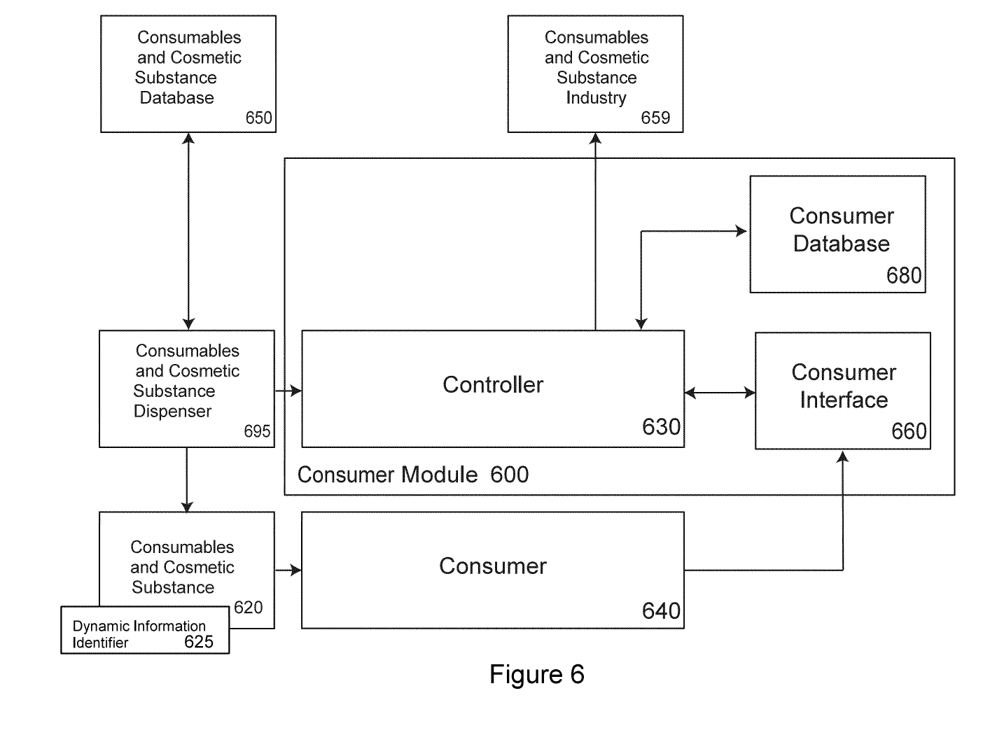

FIG. 6 shows an alternate embodiment where consumables and cosmetic substance 620 is dispensed by consumables and cosmetic substance dispenser 695. In this case, consumables and cosmetic substance dispenser 695 would already have information pertaining to consumables and cosmetic substance 620, including information on how consumables and cosmetic substance 620 was dispensed by consumables and cosmetic substance dispenser 695 and dynamic information identifier 625.

In this embodiment, controller 630 receives such information regarding consumables and cosmetic substance 620 and correlates it with consumer information from consumer interface 660 and provides it to consumables and cosmetic substance industry 659.

For example, consumables and cosmetic substance dispenser 695 dispenses a skin lotion with Aloe vera. In the process of dispensing the skin lotion with Aloe vera, consumables and cosmetic substance dispenser 695 receives various information, reads the dynamic information identifier 625, such as from a reference tag on consumables and cosmetic substance 620, the skin lotion with Aloe vera. Using the dynamic information identifier 625, consumables and cosmetic substance dispenser 695 receives, from consumables and cosmetic substance database 650, information regarding consumables and cosmetic substance 620, the skin lotion with Aloe vera. It would obtain from consumables and cosmetic substance database 650 efficacy information about the skin lotion with Aloe vera, such as ΔE or corresponding residual efficacy value, and may also retrieve source, origin and creation information. The dispenser adaptively dispenses a volume of skin lotion responsive to the ΔE or corresponding residual efficacy value, so as to dispense a specified amount of efficacy content. In a preferred embodiment, such adaptive dispensing parameters are responsive to the ΔE or corresponding residual efficacy value and consumer input or information, in particular, input or information related to the ΔE or corresponding residual efficacy value, or a desired efficacy content to be dispensed. The dispenser 695 also provides the information regarding the skin lotion with Aloe vera it received from consumables and cosmetic substance database 650 along with information it collected regarding the dispensing of the skin lotion with Aloe vera by consumables and cosmetic substance dispenser 695, to controller 630. In an embodiment, consumer module 600 is a standalone device such as a tablet computer or smartphone, and the information from consumables and cosmetic substance dispenser 695 could be transferred by means of a wireless local area network or Bluetooth connection. Consumer module 600, a smartphone for example, would obtain consumer information regarding the consumption of the consumables and cosmetic substance 620, the skin lotion with Aloe vera. Such information may include consumer feedback, observations, or measurements regarding the efficacy value of the consumables and cosmetic substance before or after dispensing.

In the case of the skin lotion with Aloe vera, the consumer 640 could be asked if their skin felt oily after application, if their skin felt softer after application, and might further be asked about the ease of application, the fragrance, and so forth. Using such information and the information from the consumables and cosmetic substance database 650, consumer module 600 can provide appropriate information to those in the consumables and cosmetic substance industry 659 who were involved in the supply chain for the skin lotion with Aloe vera. Such information could even be available to other consumers of the consumables and cosmetic substance through consumables and cosmetic substance industry 659 or consumables and cosmetic substance database 650 or consumer database 680.

In another embodiment, consumer module 600 could be part of consumables and cosmetic substance dispenser 695. In this case, the dispenser would provide user interface 660 to receive consumer information regarding the consumables and cosmetic substance 620 dispensed by consumables and cosmetic substance dispenser 695. In such a case, controller 630 likely would be the same controller which operates consumables and cosmetic substance dispenser 695.

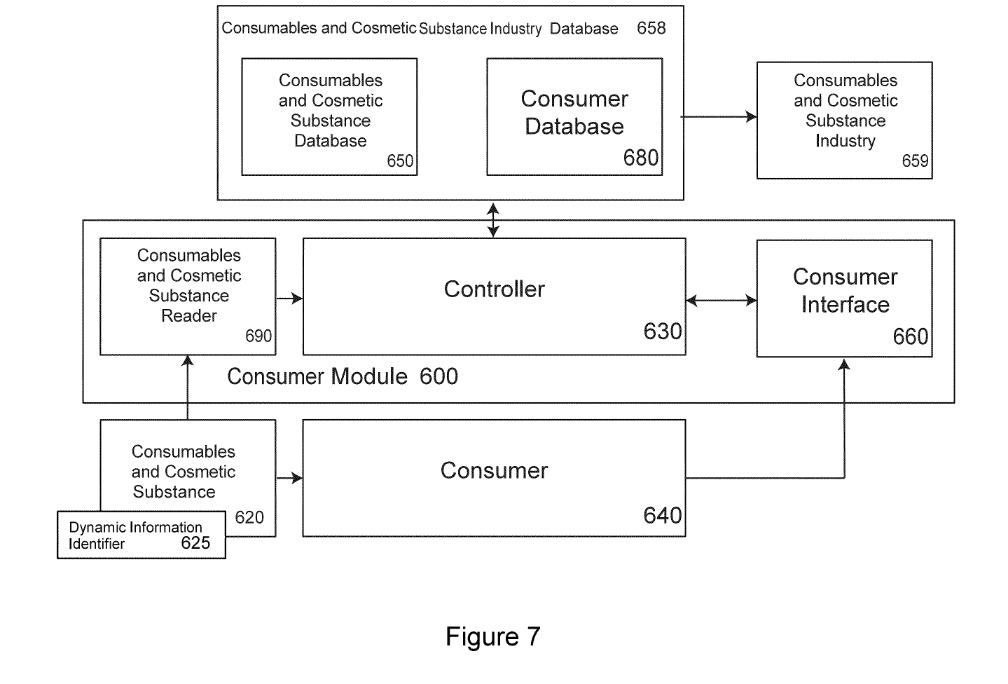

FIG. 7 shows an embodiment of consumer module 600. In the first embodiment, consumer module 600 comprises consumables and cosmetic substance reader 690, controller 630, and consumer interface 660. A consumables and cosmetic substance 620 is read by consumables and cosmetic substance reader 690 to obtain reference information in the form of a dynamic information identifier 625 regarding consumables and cosmetic substance 620. Consumables and cosmetic substance reader 690 provides the dynamic information identifier 625 to controller 630. Prior to, during, and/or following, consumption of consumables and cosmetic substance 620, consumer 640 provides information to consumer interface 660. Such information is provided by consumer interface 660 to controller 630. Controller 630 correlates the consumables and cosmetic substance information and/or the dynamic information identifier and the consumer information and provides the correlated information to consumables and cosmetic substance industry database 658, which can include consumables and cosmetic substance database 650 and/or consumer database 680. Such information may be used for creating adaptive dispensing parameters to dispense a quantity of consumables and cosmetic substance 620 responsive to the ΔE or corresponding residual efficacy value, so as to dispense a specified amount of efficacy content, and may further be used for improving consumables and cosmetic substance 620, creating new consumables and cosmetic substances, discontinuing consumables and cosmetic substances, and for marketing consumables and cosmetic substance 620. In a preferred embodiment, such adaptive dispensing parameters are responsive to the ΔE or corresponding residual efficacy value and consumer input or information, in particular, input or information related to the ΔE or corresponding residual efficacy value, or a desired efficacy content to be dispensed. Other uses of such correlated consumer information will be apparent to those in the consumables and cosmetic substance industry 659. In a further embodiment, consumer information may also be provided to the consumables and cosmetic substance industry 659. In an additional embodiment, consumer provided information could be related to observed or measured efficacy values of the consumables and cosmetic substance before or after dispensing, and is available for updating a dynamic efficacy value dataset within the consumables and cosmetic substance database 650 associated with the dynamic information identifier 625. In this case, the consumer contributes input to the dynamic consumables and cosmetic substance information available for the consumables and cosmetic substances they purchase and consume.

In an alternate embodiment, controller 630 references dynamic information identifier 625 for consumables and cosmetic substance 620 to consumables and cosmetic substance database 650 to determine those in consumables and cosmetic substance industry 659 who were involved in the creation, preserving, transforming, and/or dispensing of the consumables and cosmetic substance 620. Controller 630 may provide the consumer information regarding consumables and cosmetic substance 620 to those involved in the consumables and cosmetic substance industry 659 or may make consumer information available to other consumers of the consumables and cosmetic substance through the consumables and cosmetic substance industry database 658.

Included in the consumables and cosmetic substance industry database 658 is consumer database 680. Consumer database 680 contains specific information regarding consumer 640. Correlated information regarding the consumption of consumables and cosmetic substance 620 could be stored for future reference in consumer database 680 and is preferably correlated with dynamic information identifier 625. Such information could be used in collecting future consumer information. For example, if consumer 640 is very particular about a certain aspect of a consumables and cosmetic substance 620, controller 630 could ask for additional and/or more specific information from consumer 640 about the consumables and cosmetic substance 620 through consumer interface 660. As an example, consumer 640 may be very particular about the texture of skin lotion and the efficacy associated with its Aloe vera content. When consumables and cosmetic substance 620 is skin lotion with Aloe vera being considered for purchase, controller 630, in response to historical consumer 640 information in consumer database 680, could ask for additional information regarding the texture of the skin lotion and related to the efficacy values of its Aloe vera content, using consumer interface 660. In this case, the consumer contributes valuable input to the dynamic consumables and cosmetic substance information available for the consumables and cosmetic substances they purchase and consume.

Consumer module 600 can be implemented with discreet devices. For example, consumables and cosmetic substance reader 690 could be an optical reader such as a barcode scanner or camera capable of discerning reference information, such as a dynamic information identifier. Preferably, consumables and cosmetic substance reader 690 could be an optical reader such as a QR code scanner or camera capable of discerning reference information, such as a dynamic information identifier, and capable of discerning a URL to hardlink a user to consumables and cosmetic substance industry database 558, wherein consumables and cosmetic substance database 650 may reside. Consumables and cosmetic substance reader 690 could also be a wireless signal reader, reading RFID labels, or near field IDs. Controller 630 can be a computer, microcontroller, personal computer, laptop computer, tablet computer, or smartphone. Consumer interface 660 can be a standalone touchpad display panel which allows interaction with the consumer, but is preferably integrated into controller 630. Consumables and cosmetic substance reader 690 may also be a standalone device, or integrated into controller 630.

Preferably, consumer module 600 is an integrated device such as a tablet computer or smartphone. In this case, consumables and cosmetic substance reader 690 could be the camera located on the tablet or smartphone. Consumer interface 660 would be the touchscreen display of the tablet or smartphone. Finally, controller 630 would be the microprocessor in the tablet computer or smartphone. In this embodiment, the software to run consumer module 600 could be an app loaded onto the tablet or smartphone, designed to collect consumer information correlated to a known consumables and cosmetic substance 620 and if desired, to a known consumables and cosmetic substance dynamic information identifier 625.

In operation, consumer 640 would use the camera on the tablet computer or smartphone to read a barcode or QR code on consumables and cosmetic substance 620 providing the reference information or dynamic information identifier 625 for consumables and cosmetic substance 620. The tablet computer or smartphone would display an appropriate user interface so as to allow consumer 640 to provide information about her consumption of consumables and cosmetic substance 620. Controller 630 could query consumables and cosmetic substance database 650 using dynamic information identifier 625 regarding consumables and cosmetic substance 620 to determine those in the consumables and cosmetic substance industry who were involved in the supply chain for consumables and cosmetic substance 620 or to determine a current efficacy value of the consumables and cosmetic substance. Additionally, consumables and cosmetic substance database 650 could contain information on what information to collect from consumer 640 of the particular consumables and cosmetic substance 620 being referenced. The tablet computer or smartphone could then display an appropriate user interface so as to allow consumer 640 to provide input or information, such as regarding source, origin, or creation information or efficacy values of the consumables and cosmetic substance 620.

Such information could be provided through a connection to the internet accessed through the telecommunication system in the tablet computer or smartphone. Preferably, such a telecommunications connection would be a wireless telecommunication system communicating with consumables and cosmetic substance industry database 658. The tablet computer or smartphone would then, in the same manner, provide the consumer information regarding her consumption of consumables and cosmetic substance 620 to the consumer database 680 within the consumables and cosmetic substance industry database 658, available for use by those in consumables and cosmetic substance industry 659 involved in the supply chain of consumables and cosmetic substance 620.

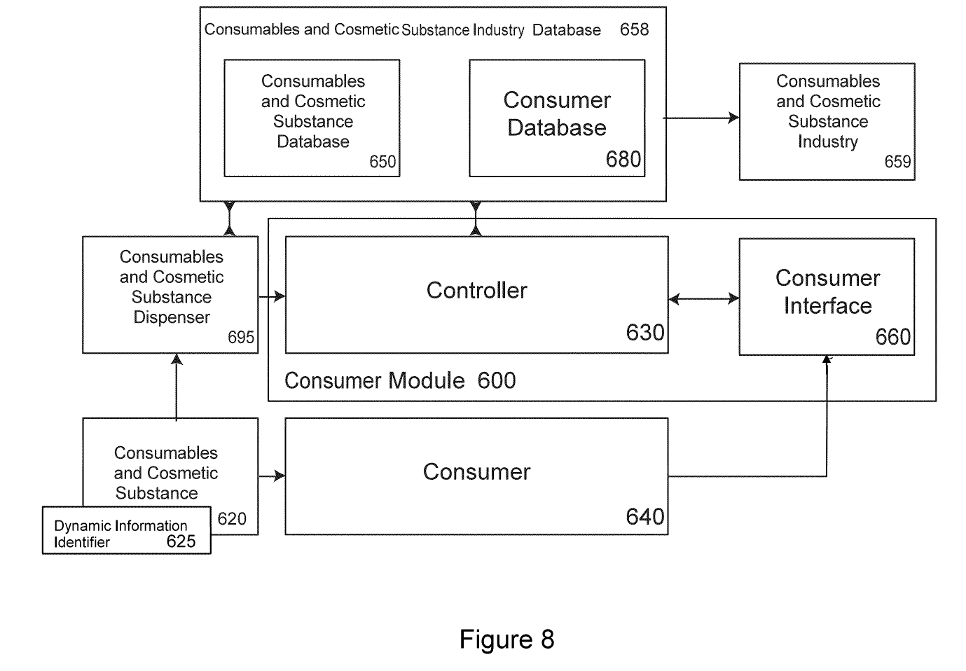

FIG. 8 shows an alternate embodiment where consumables and cosmetic substance 620 is dispensed by consumables and cosmetic substance dispenser 695. In this case, consumables and cosmetic substance dispenser 695 would already have information pertaining to consumables and cosmetic substance 620, including information on how consumables and cosmetic substance 620 was dispensed by consumables and cosmetic substance dispenser 695 and dynamic information identifier 625.

In this embodiment, controller 630 receives such information regarding consumables and cosmetic substance 620 and correlates it with consumer information from consumer interface 660 and provides it to consumables and cosmetic substance industry 659.

For example, consumables and cosmetic substance dispenser 695 dispenses a skin lotion with Aloe vera. In the process of dispensing the skin lotion with Aloe vera, consumables and cosmetic substance dispenser 695 receives various information, reads the dynamic information identifier 625, such as from a reference tag on consumables and cosmetic substance 620, the skin lotion with Aloe vera. Using the dynamic information identifier 625, consumables and cosmetic substance dispenser 695 receives, from consumables and cosmetic substance database 650, information regarding consumables and cosmetic substance 620, the skin lotion with Aloe vera. It would obtain from consumables and cosmetic substance database 650, residing within consumables and cosmetic substance industry database 658, efficacy information about the skin lotion with Aloe vera, such as ΔE or corresponding residual efficacy value, and may also retrieve source, origin and creation information. The dispenser adaptively dispenses a volume of skin lotion responsive to the ΔE or corresponding residual efficacy value, so as to dispense a specified amount of efficacy content. In a preferred embodiment, such adaptive dispensing parameters are responsive to the ΔE or corresponding residual efficacy value and consumer input or information, in particular, input or information related to the ΔE or corresponding residual efficacy value, or a desired efficacy content to be dispensed. The dispenser 695 also provides the information regarding the skin lotion with Aloe vera it received from consumables and cosmetic substance database 650 along with information it collected regarding the dispensing of the skin lotion with Aloe vera by consumables and cosmetic substance dispenser 695, to controller 630. In an embodiment, consumer module 600 is a standalone device such as a tablet computer or smartphone, and the information from consumables and cosmetic substance dispenser 695 could be transferred by means of a wireless local area network or Bluetooth connection. Consumer module 600, a smartphone for example, would obtain consumer information regarding the consumption of the consumables and cosmetic substance 620, the skin lotion with Aloe vera. Such information may include consumer feedback, observations, or measurements regarding the efficacy value of the consumables and cosmetic substance before or after dispensing.

In the case of the skin lotion with Aloe vera, the consumer 640 could be asked if their skin felt oily after application, if their skin felt softer after application, and might further be asked about the ease of application, the fragrance, and so forth. Using such information and the information from the consumables and cosmetic substance database 650, consumer module 600 can provide appropriate information to those in the consumables and cosmetic substance industry 659 who were involved in the supply chain for the skin lotion with Aloe vera. Such information could even be available to other consumers of the consumables and cosmetic substance through consumables and cosmetic substance industry 659 or consumables and cosmetic substance database 650 or consumer database 680.

In another embodiment, consumer module 600 could be part of consumables and cosmetic substance dispenser 695. In this case, the dispenser would provide user interface 660 to receive consumer information regarding the consumables and cosmetic substance 620 dispensed by consumables and cosmetic substance dispenser 695. In such a case, controller 630 likely would be the same controller which operates consumables and cosmetic substance dispenser 695.

Included in the consumables and cosmetic substance industry database 658 is consumer database 680. Consumer database 680 contains specific information regarding consumer 640. Correlated information regarding the consumption of consumables and cosmetic substance 620 could be stored for future reference in consumer database 680 and is preferably correlated with dynamic information identifier 625. Such information could be used in collecting future consumer information. For example, if consumer 640 is very particular about a certain aspect of a consumables and cosmetic substance 620, controller 630 could ask for additional and/or more specific information from consumer 640 about the consumables and cosmetic substance 620 through consumer interface 660. As an example, consumer 640 may be very particular about the texture of skin lotion and the efficacy associated with its Aloe vera content. When consumables and cosmetic substance 620 is skin lotion with Aloe vera being considered for purchase, controller 630, in response to historical consumer 640 information in consumer database 680, could ask for additional information regarding the texture of the skin lotion and related to the efficacy values of its Aloe vera content, using consumer interface 660. In this case, the consumer contributes valuable input to the dynamic consumables and cosmetic substance information available for the consumables and cosmetic substances they purchase and consume.

Controller 630 is connected to consumables and cosmetic substance industry database 658. Consumables and cosmetic substance industry database 658 contains information regarding consumables and cosmetic substances 620 in consumables and cosmetic substance database 650. Also contained in consumables and cosmetic substance industry database 658 is consumer database 680 which contains information about consumer 640.

In the preferred embodiment, consumables and cosmetic substance industry database 658 is a massive multi-dimension data base used by part or all of the consumables and cosmetic substance industry to track, store and analyze information about consumables and cosmetic substances, changes in efficacy value of consumables and cosmetic substances (ΔE), preservation of consumables and cosmetic substances, transformation of consumables and cosmetic substances, dispensing of consumables and cosmetic substances, formulations for the preparation of consumables and cosmetic substances, consumption of consumables and cosmetic substances, consumer information, and marketing of consumables and cosmetic substances.

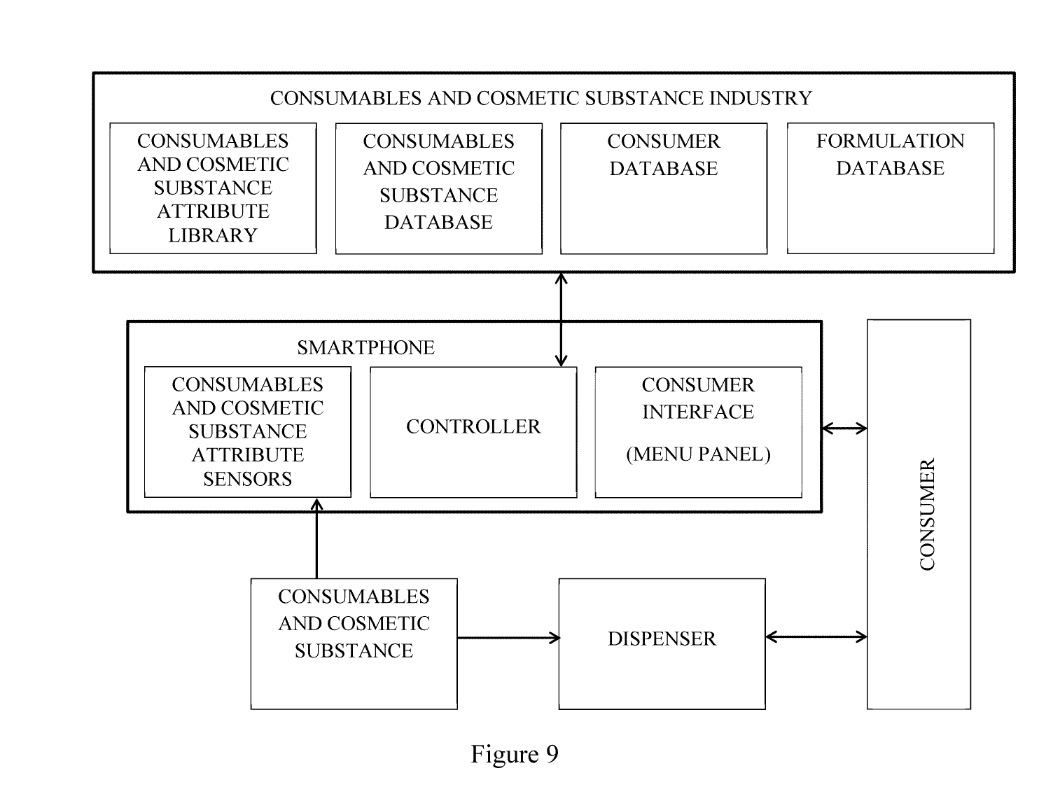

FIG. 9 shows a functional block diagram of a smartphone (including any tablet computers or other hand held devices) which can be utilized to facilitate dispensing of a consumables and cosmetic substance. The smartphone includes features enabling it to communicate with a database that facilitates identification of a current efficacy state of a consumables and cosmetic substance, wherein the database is referred to herein as a consumables and cosmetic substance attribute library. Such features may include, but are not limited to, sensors capable of measuring and collecting data related to visual appearance, optical properties, electrical properties, mechanical properties, taste, smell, volatiles, texture, touch, sound, chemical composition, temperature, weight, volume, density, hardness, viscosity, surface tension, and any other detectable attributes of consumables and cosmetic substances, which are referred to herein as consumables and cosmetic substance attribute sensors. Consumables and cosmetic substance attribute sensors may include, but are not limited to, optical sensors, laser sensors, cameras, electric noses, microphones, olfactory sensors, surface topography measurement equipment, three dimensional measuring equipment, chemical assays, hardness measuring equipment, ultrasound equipment, impedance detectors, temperature measuring equipment, weight measurement equipment, and any known sensor capable of providing data regarding a detectable attribute of a consumables and cosmetic substance. The consumables and cosmetic substance attribute library would consist of a massive database of consumables and cosmetic substance attribute data, related to the visual appearance, taste, smell, texture, touch, chemical composition and any other physical attributes of known consumables and cosmetic substances, referenced to corresponding efficacy states of known consumables and cosmetic substances. The consumables and cosmetic substance attribute library may reside within a consumables and cosmetic substance industry database, as shown in FIG. 9, wherein the consumables and cosmetic substance industry database may further comprise consumables and cosmetic substance database, consumer database, and formulation database.

Still other examples of sensor technology that might be utilized as a consumables and cosmetic substance attribute sensor include, but are not limited to: Surface plasmon resonance sensors (SPR) such as a cell phone based sensor platform disclosed by Preechaburana et at, Angew. Chem. Int. Ed. 2012, 51, 11585-11588, “Surface plasmon resonance chemical sensing on cell phones”; SPR sensors such as those disclosed by by Zhang, et al, Zhejiang University, Hangzhou 310058, P. R. China “Detection of penicillin via surface plasmon resonance biosensor”; the combination of microfluidics with Lab-on-a-Chip and Lab-on-a-Foil solutions disclosed by Focke, et al, www.rsc.org/loc, 19 Mar. 2010, “Lab-on-a-Foil: microfluidics on thin and flexible films”; Localized surface plasmon response sensors (LSPR) such as those disclosed by Roche, et al, Journal of Sensors, volume 2011, article ID 406425, doi: 10.1155/2011/406425, “A camera phone localized surface plasmon biosensing platform towards low-cost label-free diagnostic testing”; printed sensors such as those available from Thin Film Electronics ASA, for example the Thinfilm Time-Temperature Sensor; wireless pH sensors such as those discussed in IEE Sensors Journal, Vol 12, No. 3, March 2012 487 “A passive radio-frequency pH sensing tag for wireless food quality monitoring”; sensing of biological quantities such as that discussed in Appl Microbiol Biotechnol (2013) 97:1829-1840 “An overview of transducers as platform for the rapid detection of foodborne pathogens”; cell phone based E. Coli sensor using florescent imaging to detect bacteria in food and water, developed at UCLA Henry Samueli School of Engineering and Applied Science; sensors discussed in Journal of Food Engineering 100 (2010) 377-387 “Biomimetric-based odor and taste sensing systems to food quality and safety characterization: An overview on basic principles and recent achievements”; sensors discussed in Sensors 2010, 10, 3411-3443, doi 10.3390/s100403411 “Advanced Taste Sensors Based on Artificial Lipids with Global Selectivity to Basic Taste Qualities and High Correlation to Sensory Scores”; sensing described in Chem. Sci., 2012, 3, 2542 “Fluorescent DNAs printed on paper: sensing food spoilage and ripening in the vapor phase”; the use of a Silicon Integrated Spectrometer to sense food for ripeness and other qualities is described in IEEE Photonics Journal, 1 (4), p. 225-235 (2009); numerous sensing techniques described in analytica chima acta 605 (2007) 111-129 “A review on novel developments and applications of immunosensors in food analysis”; numerous sensing techniques described in J. Biophotonics 5, No. 7, 483-501 (2012)/doi 10.1002/jbio.201200015 “Surface plasmon resonance based biosensor technique: A review”; LSPR techniques to sense bitterness of tea described in Agric. Food Chem., 2010, 58 (14), pp 8351-8356 “B-Cyclodextrin/Surface plasmon response detection system for sensing bitter astringent taste intensity of green tea catechins”; a review on nano-biosensors to measure tastes and odors discussed in Bio-Nanotechnology: A revolution in food biomedical and health sciences, first edition, 2013, John Wiley & Sons, Ltd. “Nano-Biosensors for mimicking gustatory and olfactory senses”; techniques described in Science Daily, http://www.sciencedaily.com/releases/2013/02/130214111612.htm, 14 Feb. 2013 “World's most sensitive plasmon resonance sensor inspired by the ancient roman cup”; ethylene sensors discussed in Anal. Chem., 2011, 83 (16), pp 6300-6307, doi: 10.1021/ac2009756 “Electrochemical sensing of ethylene employing a thin ionic-liquid layer”; multiplex SPR techniques described in Anal Bioanl Chem (2011) 400: 3005-3011, doi 10.1007/s00216-011-4973-8 “Imaging surface plasmon resonance for multiplex microassay sensing of mycotoxins”; a review of noble metal nono-optical sensors based on LSPR by Zhao, et al, “Localized surface plasmon resonance biosensors”; colorimetric plasmon resonance imaging described by Garda, et al, Advanced Optical Materials 2013, 1, 68-76, doi: 10.1002/adom.201200040 “Colorimetric plasmon resonance imaging using nano Lycurgus cup arrays”; sensor using multiplex fiber-optic biosensor implemented by integrating multiple particle plasmon resonances (PPRs), molecular bioassays, and microfluidics is disclosed by Lin, et al, Proc. SPIE 8351, Third Asia Pacific Optical Sensors Conference, 835125 (Jan. 31, 2012), doi: 10.117/12.914383 “Multiplex fiber-optic biosensor using multiple particle plasmon resonances”; sensor based on multilayered graphene SPR-based transmission disclosed by Kim, et al, J. Nonosci. Nanotechnol, 2012 July 12(7):5381-5 “Evaluation of multi-layered graphene surface plasmon resonance-based transmission type fiber optic sensor”. It is understood that sensors may be configured to perform multiple test assays in a single use to develop a multidimensional dataset from each use.

At this juncture it can be understood that an efficacy value of a consumables and cosmetic substance can be indicated by its olfactory values or its taste values. Typically, but not necessarily, olfactory values and taste values are detectable by the human sense of smell and taste. However, consumables and cosmetic substances may emit or produce gaseous components that are not detectable or discernible by the human sense of smell, or components not detectable or discernible by the human sense of taste, but, nevertheless, these components may be indicative of a particular efficacy state of the consumables and cosmetic substance. In addition, olfactory values and taste values can be indicative of adulteration of consumables and cosmetic substances, such as by spoilage, contamination, or substitution of other consumables and cosmetic substances.

It is understood that the utilization of smartphones with consumables and cosmetic substance attribute sensors, in conjunction with the consumables and cosmetic substance attribute library, can provide beneficial information regarding a current efficacy state of consumables and cosmetic substances, or regarding adulteration or mislabeling of consumables and cosmetic substances.

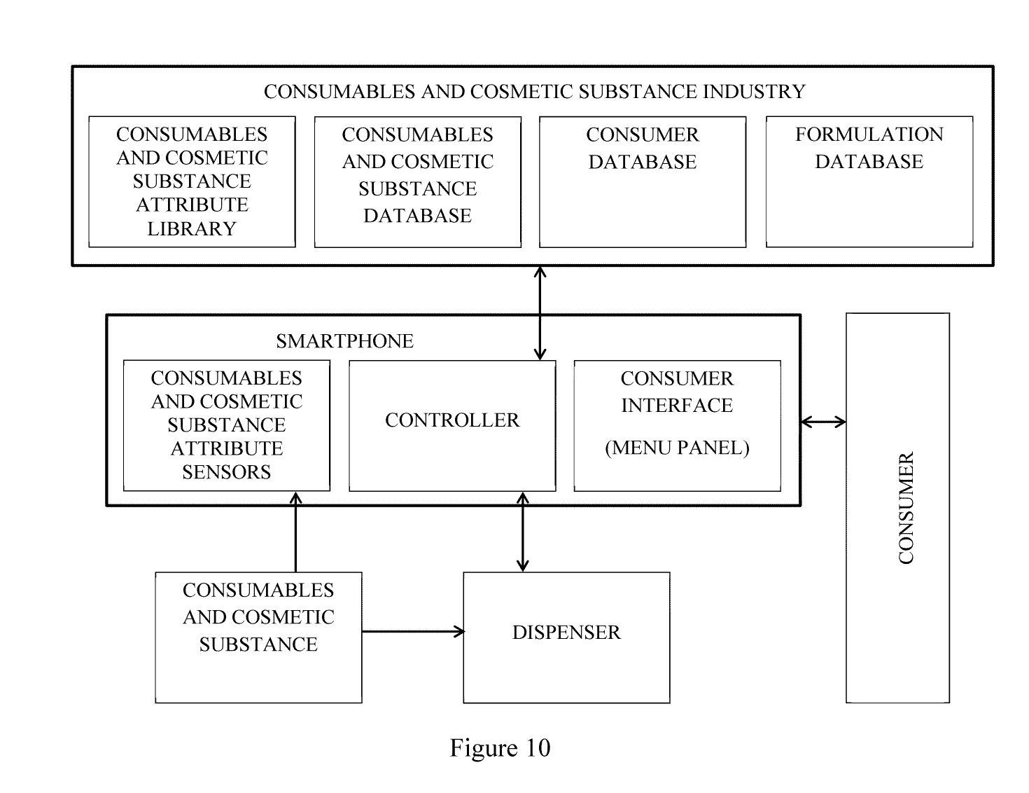

Referring to FIG. 9, a consumer uses a smartphone equipped with consumables and cosmetic substance attribute sensors to sense the consumables and cosmetic substance attribute values of an insulin medicament he wishes to prepare for injection by syringe. The consumables and cosmetic substance attribute sensors sense a variety of attribute data from the insulin medicament. The smartphone transmits the sensed attribute data to the consumables and cosmetic substance industry database, for evaluation by comparison to datasets of consumables and cosmetic substance attribute values for known consumables and cosmetic substances in known efficacy states, stored in the consumables and cosmetic substance attribute library contained therein. It is understood that while the consumables and cosmetic substance attribute library is shown as part of the consumables and cosmetic substance industry database, this only for the purposes of example and not intended to be limiting in any way, and it may reside elsewhere or may exist as an independent database. When a matching dataset is found, the matching dataset is determined to correspond to insulin, wherein the insulin is from a porcine source. In this example, the screening has also, by omission, ruled out insulin derived from bovine sources as an ingredient substitution or adulterating ingredient. In this manner, the consumer is able to screen for any number of consumables and cosmetic substance source and origin criteria reflected by the datasets in the consumables and cosmetic substance attribute library as well as determine a current efficacy state of a consumables and cosmetic substance. By way of example, and not to be limiting in any way, screening criteria may include: if a consumables and cosmetic substance is organic, mercury free, pyrogen free, and so forth; or if it contains preservatives, hormones, antibiotic residues, pesticides, environmental emissions, pollutants, heavy metals, and so forth; or if it is not apt for consumption, such as by expiration of specific efficacy values, excessive levels of spoilage surrogates such as Methane, Sulfur, acidity, microorganisms, and so forth. In this example, using the physical attribute data sensed by the smartphone from the insulin, the consumables and cosmetic substance industry database can determine that the matching consumables and cosmetic substance attribute library dataset corresponds to insulin of porcine origin, with known efficacy values, and that it is at a temperature of 40 deg. F. Thereafter, the smartphone may request input from the consumer by providing options for the consumer to choose from through the smartphone screen, also referred to herein as a dynamic consumables and cosmetic substance menu panel. The dynamic consumables and cosmetic substance menu panel provides the consumer with the ability to input his wishes to dispense the insulin by syringe injection, and further provides him with the ability to input the desired end results for the residual efficacy value that will be dispensed, such as by choosing among different possible end results offered by the dynamic consumables and cosmetic substance menu panel. The smartphone then creates, such as through an application, or retrieves from the consumables and cosmetic substance industry database, adaptive dispensing parameters that are responsive to: the current efficacy value of the insulin medicament, as determined by correlation to information in the consumables and cosmetic substance attribute library; and the consumer input obtained through the dynamic consumables and cosmetic substance menu panel. These adaptive dispensing parameters, also referred to herein as adaptive preparation sequence, are then communicated to the consumer by the dynamic consumables and cosmetic substance menu panel for implementation by the consumer. Alternatively, as shown in FIG. 10, the smartphone could communicate the adaptive preparation sequence directly to a communication compatible auto-injector, in any known fashion, for implementation by the communication compatible auto-injector. Further, the menu panel may provide the consumer with the ability to input his wishes to dispense a specified volume of insulin, in which case the smartphone then determines, such as through an application, or retrieves from the consumables and cosmetic substance industry database, the corresponding amount of residual efficacy value of the specified dose.

In the above example, the options presented to the consumer through the dynamic consumables and cosmetic substance menu panel may be presented in a format familiar to a consumer of injectable insulin. For instance, the options provided by the dynamic consumables and cosmetic substance menu panel may be “select bolus efficacy content” or “select bolus volume”. The consumer may first choose “select bolus volume”, and enter the volume of insulin that he thinks he needs. The smartphone could then determine the corresponding amount of efficacy content in the specified bolus volume and notify the consumer of the amount. The consumer may then decide to choose the option “select bolus efficacy content” and enter the amount of residual efficacy content that he actually desires. The smartphone then creates or retrieves adaptive dispensing parameters that are responsive to: the current efficacy value of the insulin medicament, as determined by correlation to information in the consumables and cosmetic substance attribute library; and the consumer input obtained through the dynamic consumables and cosmetic substance menu panel, and notifies the consumer of the bolus volume required to deliver the desired efficacy content. The smartphone may provide additional detailed information regarding the current residual efficacy value of the insulin medicament by providing a summary of the corresponding residual efficacy values, also referred to herein as a consumables and cosmetic substance residual value table. The dynamic consumables and cosmetic substance menu panel may further provide other useful information retrieved from the consumables and cosmetic substance industry database. If the consumer determines that he is not pleased with his selection based upon the more detailed information provided through the dynamic consumables and cosmetic substance menu panel, particularly the information in the consumables and cosmetic substance residual value table, he can return to the previous screen and choose another option. The consumer can continue to select options, review the more detailed information in the consumables and cosmetic substance residual value table, as well as the other useful information provided, until he determines that an option meets his requirements. Upon determining that an option meets his needs, particularly needs related to the information about residual efficacy values summarized by the consumables and cosmetic substance residual value table, the consumer can obtain the corresponding adaptive preparation sequence using the dynamic consumables and cosmetic substance menu panel, such as by selecting “proceed”. The consumer can then implement the adaptive preparation sequence that is responsive to: the information retrieved from the consumables and cosmetic substance industry database by comparing sensed physical attribute data to the consumables and cosmetic substance attribute library; and the consumer input obtained through the dynamic consumables and cosmetic substance menu panel. The adaptive preparation sequence assures that the consumer will be provided with an adaptively dispensed insulin medicament that meets his needs, particularly his needs related to the amount of residual efficacy content of the adaptively dispensed insulin medicament. Alternatively, as shown in FIG. 10, the smartphone could communicate the adaptive preparation sequence directly to a communication compatible auto-injector, in any known fashion, for implementation by the communication compatible auto-injector.

In another example of the consumer wishing to prepare insulin for injection, he uses the smartphone equipped with consumables and cosmetic substance attribute sensors to sense the consumables and cosmetic substance attribute values of an insulin medicament he wishes to prepare for injection by syringe. The smartphone transmits the sensed attribute data to the consumables and cosmetic substance industry database, for evaluation by comparison to datasets of consumables and cosmetic substance attribute values for known consumables and cosmetic substances in known efficacy states, stored in the consumables and cosmetic substance attribute library contained therein. When a matching dataset is found, the matching dataset is determined to correspond to insulin, wherein the insulin is from a bovine source and is at a known efficacy value. The smartphone notifies the consumer that the substance scanned has been correlated with bovine derived insulin, and may further notify him of its current residual efficacy value, such as by presenting a consumables and cosmetic substance residual value table. The notification prevents the consumer, who must follow an insulin regimen based on porcine derived insulin, from injecting bovine derived insulin.

In another example of the consumer wishing to prepare insulin for injection, he uses the smartphone equipped with consumables and cosmetic substance attribute sensors to sense the consumables and cosmetic substance attribute values of an insulin medicament he wishes to prepare for injection by syringe. The smartphone transmits the sensed attribute data to the consumables and cosmetic substance industry database, for evaluation by comparison to datasets of consumables and cosmetic substance attribute values for known consumables and cosmetic substances in known efficacy states, stored in the consumables and cosmetic substance attribute library contained therein. When a matching dataset is found, the matching dataset is determined to correspond to insulin, wherein the insulin is from a porcine source and is at a known efficacy value, wherein the efficacy value is below acceptable standards for injectable porcine derived insulin. The smartphone notifies the consumer that the substance scanned has been correlated with porcine derived insulin, but alerts him that the insulin has expired, as determined by its unacceptably low residual efficacy value. The smartphone may further notify him of its current residual efficacy value, such as by presenting a consumables and cosmetic substance residual value table. The alert regarding the expiration of efficacy value prevents the consumer from using expired insulin.

In another example of the consumer wishing to prepare insulin for injection, he uses the smartphone equipped with consumables and cosmetic substance attribute sensors to sense the consumables and cosmetic substance attribute values of an insulin medicament he wishes to prepare for injection by syringe. The smartphone transmits the sensed attribute data to the consumables and cosmetic substance industry database, for evaluation by comparison to datasets of consumables and cosmetic substance attribute values for known consumables and cosmetic substances in known efficacy states, stored in the consumables and cosmetic substance attribute library contained therein. When a matching dataset is found, the matching dataset is determined to correspond to insulin, wherein the insulin is from a porcine source and is at a known efficacy value, wherein the efficacy value is 75% of an established standard for efficacy of injectable porcine derived insulin. The smartphone notifies the consumer that the substance scanned has been correlated with porcine derived insulin, and further notifies him of its current residual efficacy value, such as by presenting a consumables and cosmetic substance residual value table. He quickly determines from the consumables and cosmetic substance residual value table that the insulin correlates to insulin that has lost a significant amount of its initial efficacy value. However, he knows that by choosing the “select bolus efficacy content” option he will be provided with adaptive dispensing parameters that allow him to dispense a volume of insulin that provides the specified bolus efficacy content. He chooses “select bolus efficacy content” and the smartphone determines or retrieves adaptive dispensing parameters, wherein the adaptive dispensing volume in ml may be calculated: Adaptive Dispensing Volume=(Desired Efficacy Content)/(0.75×(established standard for efficacy value/ml injectable porcine derived insulin)).

It is understood that consumables and cosmetic substance attribute sensors can beneficially be provided with, or combined with, any consumables and cosmetic substance module, including, but not limited to, creation, transformation, preservation, dispensing, consumer, and information. It is understood that consumables and cosmetic substance attribute sensors can beneficially be provided with, or combined with, devices other than smartphones, including: any handheld device: storage device, container, package, or environment; preservation system; dispensing system; appliance, and so forth. This would enable a wide array of users and scenarios wherein consumables and cosmetic substances can be identified and their current efficacy state can be determined.

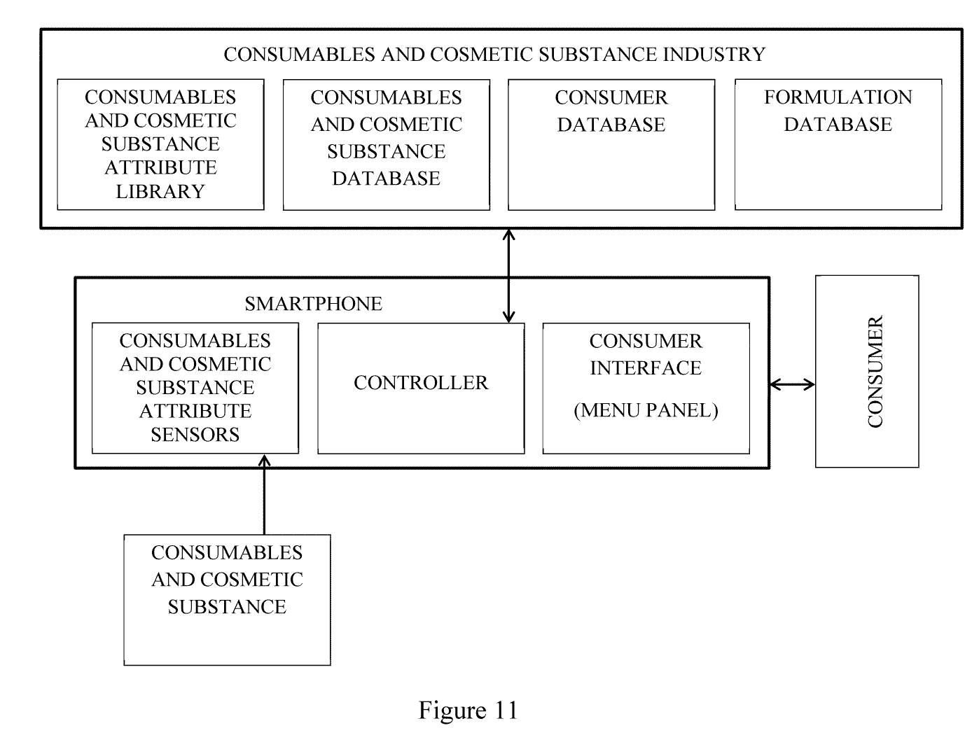

FIG. 11 shows a functional block diagram of how a smartphone (including any tablet computers or other hand held devices) may be provided with, or paired with, consumables and cosmetic substance attribute sensors. Such consumables and cosmetic substance attribute sensors may comprise devices incorporated into smartphones by the smartphone manufacturer, separate devices in communication with the consumer's smartphone, wherein such communication is accomplished by any communication format known to one skilled in the art. Communication formats may include, but are not limited to: hardwire connection, external electronic plugs such as USB or any custom plug configuration; wireless connection such as WiFi or Bluetooth; optical connection; RF connection; and any other communication format.

Consumables and cosmetic substance attribute sensors may be provided in any physical form known to one skilled in the art, including devices permanently, temporarily, or never physically attached to smart phones. These forms include, but are in no way limited to: devices permanently incorporated into a smartphone; devices permanently attached to a smartphone; devices temporarily attached to a smartphone; modular devices removably attached to a smartphone; devices such as cases that decorate or protect a smartphone; devices that plug into communication ports of a smartphone, such as by a USB or other connector; near-field communication devices such as Bluetooth devices, RF devices, or any other near-field communication device, which may, or may not, be in physical contact with a smartphone.

It is understood that consumables and cosmetic substance attribute sensors may be provided in any combination of physical form and communication format in relation to a smartphone. While examples of smartphones enabled by consumables and cosmetic substance attribute sensors are provided herein, they are provided for the purpose of explanation and are in no way limiting.

In one example of a smartphone equipped with consumables and cosmetic substance attribute sensors, a consumer is provided with an antibiotic suspension he has not taken before. He does not recognize the antibiotic name on the label of the bottle, but he knows that he is allergic to Penicillin and want to verify that the suspension contains no Penecillin. The consumer can use the smartphone to verify that the suspension has no Penicillin. The consumer launces an application on his smartphone, herein referred to as a sensing application, that will determine his consumables and cosmetic substance information needs, identify if necessary consumables and cosmetic substance attribute sensors are available to determine the required information, instruct him on the use of the necessary consumables and cosmetic substance attribute sensors, and provide to him feedback responsive to his consumables and cosmetic substance information needs and the data provided by the consumables and cosmetic substance attribute sensors.

To determine the consumer's consumables and cosmetic substance information needs, also referred to herein as consumer input, the application may provide the consumer with various options and prompts, such as, but not limited to: one or more menu panels providing visual prompts and options on the smartphone screen; through various audible prompts and options provided through the smartphone speaker, preferably in language format; through any combination of visual and audible prompts and options; and through any prompt or option capable of being communicated by a smartphone. In this example, the consumer may be provided with a first broad option, such as, but not limited to, “consumables and cosmetic substance ingredient confirmation”, “consumables and cosmetic substance ingredient exclusion”, “consumables and cosmetic substance adulteration exclusion”, or “more options”. He is interested in ruling out Penicillin as a possible ingredient in the antibiotic suspension, so he selects the “consumables and cosmetic substance ingredient exclusion” option. The application then provides him with the ability to provide input regarding what consumables and cosmetic substance ingredient he is interested in excluding, such as by allowing the consumer to type the word “Penicillin”, speak the word “Penicillin”, or select “Penicillin” from a library of consumables and cosmetic substance choices presented by the application through the smartphone. The consumer provides the requested consumer input, for example by selecting “Penicillin” from a menu of options presented by the menu panel.

The application would then search for consumables and cosmetic substance attribute sensors necessary to identify Penicillin. If the necessary consumables and cosmetic substance attribute sensors are not identified, or are identified but not in communication with the application, the consumer is notified of the issue. Once the application has identified that the necessary efficacy attribute sensors are communicating with the application, the application provides the consumer with instructions, through the smartphone, regarding required interaction between the antibiotic suspension and the necessary efficacy attribute sensors.

Interaction between the consumables and cosmetic substance and the necessary efficacy attribute sensors may take many forms, which include, but are not limited to: placing a small portion of the consumables and cosmetic substance on, or inside of, an external window, target, port, or protrusion of the smartphone where the necessary consumables and cosmetic substance attribute sensors can sense the consumables and cosmetic substance to determine values corresponding to the consumer input; placing a small portion of the consumables and cosmetic substance on, or inside of, a disposable or reusable sample carrier and inserting the sample carrier into a port where the necessary consumables and cosmetic substance attribute sensors can sense the consumables and cosmetic substance to determine values corresponding to the consumer input; advancing a probe carrying the necessary sensors (such as but not limited to an antenna, rod, needle, surface, or wire) into the consumables and cosmetic substance; and placing the necessary consumables and cosmetic substance attribute sensors in close proximity to the consumables and cosmetic substance such that volatiles or gaseous components emitted by the consumables and cosmetic substance may be sensed. It is understood that any known sensing technologies may be utilized, and include direct and indirect interaction with the consumables and cosmetic substance as well as direct and indirect interaction with indicators or probes placed in contact with, or in proximity to, the consumables and cosmetic substance.

The instructions provided through the smartphone regarding required interaction between the consumables and cosmetic substance of interest and the necessary efficacy attribute sensors may be augmented by various visual, audible, and tactile feedback provided to the consumer through the smartphone. By way of example only, and not in any way intended as limiting, these may include: illuminating an external window, target, port, or protrusion of the smartphone where the small portion of consumables and cosmetic substance is to be placed; illuminating a port where a disposable or reusable sample carrier containing a small portion of the consumables and cosmetic substance of interest is to be placed; recognition and confirmation of external efficacy attribute sensors communicating with the sensing application through any connection known to one skilled in the art, including, but not limited to, external connectors such as USB or custom, Bluetooth, WiFi, RF, and optical capabilities; calibration and confirmation of necessary consumables and cosmetic substance attribute sensors; and calibration and confirmation of disposable or reusable sample carriers.

After sensing the antibiotic suspension and obtaining corresponding attribute values, the application can determine if Penicillin is, or is not, present in the suspension. This could be accomplished by comparing the sensed attribute values to a consumables and cosmetic substance attribute library of sensed values for known Penicillin and Penicillin surrogates. Such a library of sensed values for known Penicillin or Penicillin surrogates may exist: as part of the consumables and cosmetic substance information module; as part of a database provided by the manufacturer of the consumables and cosmetic substance attribute sensors or the application provider; as part of a database provided by the pepper growers or distributors; as part of the consumables and cosmetic industry database, or as part of any other type of database. Such a library of sensed values may exist as part of the smartphones local memory, may exist in the “fog”, or may exist in the “cloud”. If a matching dataset is identified in the library of sensed values for known Penicillin or Penicillin surrogates, the application could notify the consumer that the antibiotic suspension contains Penicillin and alert him that it is not in compliance with his consumer input that Penicillin is a “consumables and cosmetic substance ingredient exclusion”. If no matching dataset is identified in the library of sensed values for known Penicillin or Penicillin surrogates, the application could notify the consumer that the antibiotic suspension contains no Penicillin and confirm that it is in compliance with his consumer input that Penicillin is a “consumables and cosmetic substance ingredient exclusion”. Such notifications, alerts, and confirmations may be provided in any format, or combination of formats, available through the smartphone, including, but not limited to, language, symbolic, tactile, olfactory, thermal, visual, and audible.

In another example, a consumer is getting ready to take an Omega oil supplement in the form of a gel cap. He is concerned that when he opens the gel cap bottle, he momentarily smelled an unusual odor. The consumer want to rule out that the product could be adulterated by spoilage, and decides to use his smartphone to figure this out. He launches the sensing application on his smartphone. To determine his consumables and cosmetic substance information needs, the application provides the consumer with a first broad option, such as “consumables and cosmetic substance ingredient confirmation”, “consumables and cosmetic substance ingredient exclusion”, “consumables and cosmetic substance adulteration exclusion”, or “more options”. He is interested in ruling out spoilage of the gel caps, so he selects the “consumables and cosmetic substance adulteration exclusion” option. The application then provides him with a list of consumables and cosmetic substance categories, such as by allowing the consumer to select from choices including, but not limited to: “vitamins and supplements”, “personal hygiene”, “cosmetics”; “medicaments”; and so forth, from a library of consumables and cosmetic substance categories presented by the application through the smartphone. In this example, he chooses “vitamins and supplements”, and is presented with more specific choices including “Omega oil gel cap”. The consumer provides the requested input, for example by selecting “Omega oil gel cap” from a menu of options presented by the menu panel. The application then provides him with a list of adulteration categories, such as by allowing the consumer to select from choices including, but not limited to, “spoilage”, “pathogens”, “Mercury”, “chemical preservatives”, “ingredient substitution”, and so forth, from a library of adulteration categories presented by the application through the smartphone. The consumer identifies the “spoilage” option corresponding to his original concern regarding spoilage, and realizes upon seeing the “Mercury” option that he is also concerned about ruling out excessive levels of Mercury in the Omega oil, which was likely derived from fish. He provides his consumer input by selecting “spoilage” and “Mercury”.

The application would then search for consumables and cosmetic substance attribute sensors necessary to identify spoilage, or spoilage surrogates, in the Omega gel caps. It would also search for consumables and cosmetic substance attribute sensors necessary to identify Mercury in the Omega oil gel caps. If the necessary consumables and cosmetic substance attribute sensors are not identified, or are identified but not in communication with the application, the consumer is notified of the issue. Once the application has identified that the necessary efficacy attribute sensors are communicating with the application, the menu panel provides the consumer with instructions regarding required interaction between the Omega oil gel caps and those efficacy attribute sensors. It is understood that the consumables and cosmetic substance attribute sensors necessary to evaluate spoilage may, or may not, be the same consumables and cosmetic substance attribute sensors necessary to evaluate Mercury. It is further understood the interaction between the Omega oil gel caps and the consumables and cosmetic substance attribute sensors may, or may not, be the same for evaluating spoilage and evaluating Mercury.

In this example, and not to be limiting in any way, the sensing application identifies that the consumer input regarding spoilage of the Omega oil gel caps requires an efficacy attribute sensor provided with the smartphone. The sensor to be utilized may be an olfactory sensor or electronic nose provided with the smartphone which can detect gaseous spoilage surrogates, for example Methane. The olfactory sensor or electronic nose resides within a carrier receiving port of the smartphone, possibly along with other consumables and cosmetic substance attribute sensors. The receiving port is configured to receive a disposable or reusable consumables and cosmetic substance sample carrier, wherein a small portion of a consumables and cosmetic substance, in this case an Omega oil gel cap, is placed on or within the sample carrier such that the consumables and cosmetic substance attribute sensors residing within the carrier receiving port can sense the consumables and cosmetic substance.

It is understood that many configurations of sample carriers are possible, and may enable direct, indirect, contact, and non-contact interface with various consumables and cosmetic substance attribute sensors. Examples are provided herein for illustrative purposes and not intended to be limiting in any way. For example, the olfactory sensor or electronic nose may be positioned within the carrier receiving port such that when the sample carrier is inserted, the olfactory sensor or electronic nose is sealingly engaged with a vent provided on the sample carrier. In this way gaseous emissions from a consumables and cosmetic substance carried by the sample carrier can be collected in a controlled and repeatable fashion. An optical sensor may be positioned adjacent a clear wall or window of the sample carrier, wherein the optical sensor can detect a consumables and cosmetic substance carried by the carrier. Various chemical or biologic sensors may be positioned adjacent an opening in a wall of the sample carrier, or alternatively, adjacent a septum or membrane covering an opening in the wall of the sample carrier, such that the various chemical or biologic consumables and cosmetic substance attribute sensors can be placed into direct contact with a consumables and cosmetic substance carried by the sample carrier. Electronic sensors can be positioned to engage electrically conductive leads contacting a consumables and cosmetic substance carried by the sample carrier. A hardness tester or force gage can be positioned adjacent an opening in the wall of the sample carrier such that it can be advanced into a consumables and cosmetic substance carried by the sample carrier to sense its tactile characteristics.

In the example regarding the Omega oil gel cap, the sensing application instructs the consumer, through the smartphone, to place a small portion of the Omega oil gel cap within the sample carrier and insert the sample carrier into the carrier receiving port on the smartphone. When the insertion of the sample carrier is detected, the sensing application initiates the sensing of the sample by the olfactory sensor or electric nose. Based upon the sensed values, the application can determines if spoilage has, or has not, occurred in the Omega oil gel cap. This could be accomplished by comparing the sensed values to a consumables and cosmetic substance attribute library of sensed values for known Omega oil gel caps that have spoiled. Such a library of sensed values for known Omega oil gel caps that have spoiled could exist as part of the consumables and cosmetic substance information module, might exist as part of a database provided by the manufacturer of the consumables and cosmetic substance attribute sensors, the application provider, fishing industry creators or distributors, the consumables and cosmetic substance industry database, or any other type of database. Such a library of sensed values may exist as part of the smartphone's local memory, or might exist in the “fog” or in the “cloud”. If a matching dataset is identified in the library of sensed values for known Omega oil gel caps that have spoiled, the application could alert the consumer that the Omega oil gel cap has spoiled and is not in compliance with the consumer input that “spoilage” is a “consumables and cosmetic substance adulteration exclusion”. If no matching dataset is identified in the library of sensed values for known Omega oil gel caps that have spoiled, the application could notify the consumer that the Omega oil gel cap is not spoiled and is in compliance with the consumer input that “spoilage” is a “consumables and cosmetic substance adulteration exclusion”. Such notification may be through any format, or combination of formats, available through the consumer's smartphone, including, but not limited to, language, symbolic, tactile, olfactory, thermal, visual, and audible. In this example, the consumer is notified through his smartphone that the Omega oil gel cap is in compliance with his input regarding spoilage.

The sensing application now notifies the consumer through the smartphone that no sensors to evaluate the consumers input regarding Mercury have been detected. The consumer has a consumables and cosmetic substance Mercury sensor in a kitchen drawer. Such a sensor may be, but is not limited to, a handheld, battery operated Bluetooth device, including a disposable probe, paddle, container, or surface of any kind, to interact with consumables and cosmetic substances. The consumables and cosmetic substance Mercury sensor may further comprise any means known to one skilled in the art by which Mercury values can be detected, and any means known to one skilled in the art by which to communicate the results to the smartphone for use by the sensing application. In this example, the communication with the smartphone is accomplished with Bluetooth connection. The means by which Mercury values can be detected may include, but are not limited to, biosensors, chemical sensors, conductometric sensors, microcantilevel sensors, SAW sensors, piezoelectric sensors, and nanosensors similar to those described by: Selid et al, Sensors 2009, 9, 5446-5459; doi: 10.3390/s90705446; and Katherine Davies, Royal Society of Chemistry, Chemistry World, New chemosensor for mercury detection (http://www.rsc.org/chemistryworld/Issues/2005/July/mercury_detection.asp). The consumer turns on the consumables and cosmetic substance Mercury detector, it is recognized by the smartphone, and can now communicate values it senses corresponding to Mercury in the Omega oil gel caps. The consumer places the sensor probe in contact with an Omega oil gel cap as instructed to accomplish the interaction necessary to evaluate the consumer input that “Mercury” is a “consumables and cosmetic substance adulteration exclusion”. Based upon the sensed values, the application can determine if Mercury levels have, or have not, exceeded acceptable levels in the Omega oil gel cap. This could be accomplished by comparing the sensed values to a consumables and cosmetic substance attribute library of sensed values for known Omega oil gel caps with acceptable Mercury levels, or alternatively may be determined by comparison to an absolute standard or other predetermined limit. If the sensed values for Mercury in the Omega oil gel cap indicate unacceptably high Mercury levels, the application could alert the consumer that the Omega oil gel cap has excessive Mercury content and is not in compliance with the consumer input that “Mercury” is a “consumables and cosmetic substance adulteration exclusion”. If the sensed values for Mercury in the Omega oil gel cap indicates acceptably low Mercury levels, the application could notify the consumer that the Omega oil gel cap does not contain excessive Mercury and is in compliance with the consumer input that “Mercury” is a “consumables and cosmetic substance adulteration exclusion”. Such notification may be through any format, or combination of formats, available through the consumer's smartphone, including, but not limited to, language, symbolic, tactile, olfactory, thermal, visual, and audible. In this example, the consumer is notified through his smartphone that the Omega oil gel cap is in compliance with his input regarding Mercury. He now has confidence that he can consume the Omega oil gel caps.

In another example, a consumer is interested in determining if a particular consumables and cosmetic substance contains caffeine, and if it does, what is the current residual efficacy value associated with the caffeine. Using his smartphone, he launches the sensing application on the smartphone. In this example, the consumer may instruct the smartphone vocally, as facilitated by numerous applications available for smartphones. He is interested in determining if caffeine is present, and if so, what its current residual efficacy value may be, so he makes his selection by speaking “caffeine content”. The smartphone then seeks confirmation of the consumer's selection, such as by saying “you are interested in caffeine content”, to which he verbally replies “yes”.

The application then searches for consumables and cosmetic substance attribute sensors necessary to identify caffeine, identifies that the necessary efficacy attribute sensors are communicating with the application, and provides the consumer with instructions, through the smartphone, regarding required interaction between the particular consumables and cosmetic substance and the necessary efficacy attribute sensors. In this example, the sensor is part of a set of sensors provided with a smartphone outer case. The outer case may communicate with the smartphone in any known fashion, but for the purpose of this example, it communicates with the smartphone via an electrical connector. The sensors provided with the outer case enable a consumer to determine three very common questions regarding consumables and cosmetic substance: Does it have caffeine?; Does it contain sugar?; and What is its temperature?

It is understood that various types of sensors may be provided in individual or combined formats to answer these questions, and the individual and combined formats discussed herein are offered by way of example only and not intended to be limiting in any way. It is also understood that the utility of the specific sensors utilized, individually or in combination, extends to many other consumables and cosmetic substances, and nutritional substances, that can be sensed with the chosen sensor configuration and sample interface format. Further, it is understood that any type and number of consumables and cosmetic substance attribute sensors may be provided in communication with a smartphone, and could be provided in formats to address common questions, such as in this example of the smartphone outer case, or provided in custom formats according to a consumer's consumables and cosmetic substance information needs.

In one example of a smartphone outer case, it is provided with two distinct sensor probes and one distinct sensor port. The first sensor probe is configured as a telescopic antenna and is associated with a caffeine sensor. The second sensor probe is configured as a telescopic antenna and is associated with a sugar detector. The sensor port is configured as a small glass window and is associated with a temperature sensor. In this example, the caffeine sensor may be similar to those described by: Chung I C, et al, J Nanosci Nanotechnol. 2011 December; 11(12):10633-8, A portable electrochemical sensor for caffeine and (−)epigallocatechin gallate based on molecularly imprinted poly(ethylene-co-vinyl alcohol) recognition element; or Ebarvia, et al, Analytical and Bioanalytical Chemistry, March 2004, Volume 378, Issue 5, pp 1331-1337, Biomimetic piezoelectric quartz sensor for caffeine based on a molecularly imprinted polymer; or Zhao, et al, http://www.researchgate.net/publication/225410860, Department of Material and Chemistry Engineering, Henan Institute of Engineering, Zhengzhou, 450007 China, Article-Voltammetric sensor for caffeine based on a glassy carbon electrode modified with Nafion and graphene oxide. The sugar sensor may be similar to those described by: Kumar, et al, http://www.researchgate.net/publication/225803614, Study of fiber optic sugar sensor; or Scampicchio, et al, Nanotechnology 20 135501 doi:10.1088/0957-4484/20/13/135,501, Issue 13, 1 Apr. 2009, Optical nanoprobes based on gold nanoparticles for sugar sensing. The temperature sensor may be similar to those manufactured by MICRO-EPSILON, and described at www.micro-epsilon as miniature non-contact IR sensors thermoMETER CSmicro and non-contact IR sensors with laser aiming thermoMETER CSlaser.

Upon identifying the caffeine sensor, the application instructs the consumer to place the caffeine sensor probe into the particular consumables and cosmetic substance for 5 seconds. The consumer extends the caffeine sensor probe and places it in the particular consumables and cosmetic substance as instructed. The sensed values corresponding to caffeine are compared to a consumables and cosmetic substance attribute library of sensed values for various caffeine concentrations, including no caffeine, or alternatively compared to predetermined values for various caffeine concentrations in solution, including no caffeine. When a match is determined, the consumer is notified of the result through his smartphone. In this case, no caffeine is detected.

However, while sensing the particular consumables and cosmetic substance with the caffeine sensor, the consumer is impressed that it seems unusually warm. He enables the use of the temperature sensor by returning to the appropriate screen and speaking “substance temperature”. The smartphone then seeks confirmation of the consumer's selection, such as by speaking “you are interested in substance temperature”, to which he verbally replies “yes”.

The application then searches for consumables and cosmetic substance attribute sensors necessary to identify temperature of a consumables and cosmetic substance, identifies that the necessary attribute sensors are communicating with the application, and provides the consumer with instructions, through the smartphone, regarding required interaction between the particular consumables and cosmetic substance and the necessary efficacy attribute sensors. In this example, the sensor is part of the set of sensors provided with the smartphone outer case.

Upon identifying the temperature sensor, the application instructs the consumer to position the temperature sensor window near the particular consumables and cosmetic substance such that the sensor's aiming lasers converge to form a single dot at its surface. The consumer follows the instructions to sense the values corresponding to temperature and the sensed values are compared to an attribute library of sensed values for various temperatures. When a match is determined, the consumer is notified of the corresponding temperature through his smartphone. In this case the consumer is informed that the particular consumables and cosmetic substance is at 40° F. If the temperature were potentially harmful to a consumer, for example 190° F., the consumer may also receive an alarm or warning from his smartphone.

In an alternate example, the smartphone outer case is provided with a single probe through which the caffeine sensor, sugar sensor, and temperature sensor are utilized. In this example, the caffeine and sugar sensors may be similar to those previously described, but the temperature sensor may be any thermocouple type sensor suitable for contact sensing of temperature. In this example, the consumer prompts the sensing application, as previously described, regarding “caffeine content”. The application identifies the caffeine sensor, and further identifies that it is also commonly used in conjunction with a sugar sensor and temperature sensor, or alternatively identifies that it is provided on a single sensor probe that also senses sugar and temperature.

The application enables the sensing of values corresponding to caffeine, enables the sensing of values corresponding to sugar, enables the sensing of values corresponding to temperature, and instructs the consumer to place the sensor probe into the particular consumables and cosmetic substance for 5 seconds. The consumer extends the sensor probe and places it in the particular consumables and cosmetic substance as instructed. The sensed values corresponding to caffeine are compared to a consumables and cosmetic substance attribute library of sensed values for various caffeine concentrations, the sensed values for sugar are compared to a consumables and cosmetic substance attribute library of sensed values for various sugar concentrations, and the sensed values for temperature are compared to an attribute library of sensed values for various temperatures. When matches are determined, the consumer is notified of the result through his smartphone. In this case, he is notified that no caffeine is detected, no sugar is detected, and the temperature is 40° F. If caffeine or sugar had been present, the sensed values would have been correlated to known concentrations of caffeine or sugar, and the corresponding current residual efficacy value could be communicated by the smartphone to the consumer, such as by a residual value table.

In other embodiments, packaged consumables and cosmetic substances are sensed by consumables and cosmetic substance attribute sensors without disrupting the integrity of the package. As used herein, a consumables and cosmetic substance package is any type of consumables and cosmetic substance container, storage device or recipient, including, but not limited to, cups, bottles, glasses, bags, boxes, wrappers, and so forth. In some embodiments this is accomplished with existing packaging. In other embodiments, consumables and cosmetic substance packaging is provided to enable sensing of consumables and cosmetic substance attribute values without opening the package. As will be explained, such packaging may incorporate non-contact interface ports, such as a glass or plastic window of known refractive index, into the consumables and cosmetic substance packaging, wherein such ports allow interaction between a consumables and cosmetic substance attribute sensor and the consumables and cosmetic substance without disrupting the package integrity. This may also be accomplished by incorporating product contact portions of a consumables and cosmetic substance attribute sensor into the consumables and cosmetic substance packaging, and providing ports allowing interaction between the product content portions and the consumables and cosmetic substance attribute sensor without disrupting the package integrity. Alternatively, this may be accomplished by further providing the product contact portion with the ability to transmit sensed values to a device equipped to receive such transmission, such as a smartphone. Providing consumers with the ability to determine corroborating evidence of the authenticity of consumables and cosmetic substances packaged with known packaging, and the residual efficacy values, such as by sensing consumables and cosmetic substance attribute values using their smartphone and without disrupting the integrity of the package, and providing packages that widely expand the consumer's ability to do so, provides great utility and benefit for consumers.

Examples of using smartphones with consumables and cosmetic substance attribute sensors to determine efficacy values of a packaged consumables and cosmetic substance without disrupting the integrity of the package are now provided. In the examples, a smartphone is provided with a variety of sensors, and as will be explained, the sensors may comprise an entire consumables and cosmetic substance attribute sensor, or a non-contact portion of a consumables and cosmetic substance attribute sensor, depending upon their application. Application of such smartphones may be to determine attribute values from: consumables and cosmetic substances provided in known packaging, including no packaging; consumables and cosmetic substances provided in packaging incorporating product contact portions of the consumables and cosmetic substance attribute sensor into the consumables and cosmetic substance packaging and providing ports allowing interaction between the product content portion and the consumables and cosmetic substance attribute sensor without disrupting the package integrity; or consumables and cosmetic substances provided in packaging incorporating product contact portions of the consumables and cosmetic substance attribute sensor into the consumables and cosmetic substance packaging and further providing the product contact portion with the ability to transmit sensed values to a smartphone equipped to receive such transmission.

In an example, a smartphone is provided with a consumables and cosmetic substance attribute sensor similar to those manufactured by MICRO-EPSILON, and described at www.micro-epsilon as fixed lens color sensors color SENSOR OT-3-GL and OT-3-LU. Such sensors illuminate a surface with white light and sense the reflected color values, and are particularly useful for color recognition of non-homogeneous targets and glossy targets, and can also provide useful information regarding attributes of liquids, including the turbidity of the liquids. In this example, a nurse could utilize the smartphone to determine useful information regarding a current residual efficacy value of a collagen-based wound dressing packaged in a clear plastic pouch in the supply room of a hospital. He uses the fixed lens color sensor on his smartphone to sense the reflected color values from a first pouch containing the desired collagen-based wound dressing. The smartphone communicates with a consumables and cosmetic substance attribute library containing a database of sensed reflected color values for packaged collagen-based wound dressings, and determines a match. The matching dataset correlates to a collagen-based wound dressing that is significantly oxidized and therefore has a very low efficacy value. The smartphone notifies the nurse of this information, such as by presenting a residual value table, and he senses other collagen-based wound dressing packages from the same box and receives similar notification from his smartphone. The nurse decides to check a newer box of collagen-based wound dressings. He uses the fixed lens color sensor on his smartphone to sense the reflected color values from a first package from the newer box. The smartphone communicates with a consumables and cosmetic substance attribute library containing a database of sensed reflected color values for packaged collagen-based wound dressings, and determines a match. The matching dataset corresponds to collagen-based wound dressing that is not oxidized, or is minimally oxidized, and therefore has a high efficacy value. The smartphone notifies the nurse of this information, such as by presenting a residual value table, and he decides to use the corresponding packaged collagen-based wound dressing. It is understood that the smartphone may be used to sense an unpackaged collagen-based wound dressing in the same fashion.

In another example, a smartphone is provided with a consumables and cosmetic substance attribute sensor similar to those manufactured by MICRO-EPSILON, and described at www.micro-epsilon as fiber color sensors, colorSENSOR LT-1-LC-20, WLCS-M-41, and LT-2. Such sensors use a modulated white light LED to project a spot onto or through a target, and focusing part of the reflected or transmitted light with fiber optic onto a color detector element. Common sensing techniques include, but are not limited to: projecting a spot directly on and normal to an inspection target and focusing part of the back-scattered light with fiber optic onto a color detector; projecting a spot indirectly, that is at an angle to, an inspection target and focusing part of the reflected light with fiber optic onto a color detector; and projecting a spot directly through an inspection target and focusing part of the transmitted light with fiber optic onto a color detector. The consumables and cosmetic substance attribute sensor provided with such a smartphone may be configured to include a white light source and color detector as a permanent part of the smartphone, and a coupler that enables attachment to the mating coupler of various removable fiber optic probe configurations to project light from the light source onto or through a target and to focus reflected or transmitted light from the target onto the color detector. Such removable fiber optic probes may be provided as stand-alone devices to facilitate any known color sensing technique achievable with this type of sensor. For example, the consumer may be a cosmetics process engineer who wishes to check the dissolved sugar content of a specific liquid reagent with his smartphone. Using his smartphone, he is notified that the removable “transmission” probe is required for the task. He attaches the removable “transmission” probe to the sensor coupler provided on his smartphone, and is instructed to submerge it into the specific liquid reagent. The removable “transmission” probe coupled to the sensor coupler enables the sensing of color transmission values from the reagent when the color sensor is activated. The currently sensed color values are compared to a consumables and cosmetic substance attribute library of sensed color transmission data for known dissolved sugar concentrations. When a matching dataset is identified, the smartphone informs the consumer of the corresponding sugar concentration, which corresponds to the reagent's current residual efficacy value related to dissolved sugar. In another example, a nurse wants to know the current residual efficacy value of a wound dressing he is about to apply, but it is already open. He is notified by his smartphone that the removable “backscatter” probe is required for the task. He attaches the removable “backscatter” probe to the sensor coupler provided on his smartphone, and is instructed to position the probe 1 cm away from the wound dressing at a normal angle. The removable “backscatter” probe coupled to the sensor coupler enables the sensing of reflected color values backscattered from the wound dressing, which are compared to a consumables and cosmetic substance attribute library of sensed color values backscattered from known wound dressings with various levels of oxidation. When a matching dataset is identified, the smartphone informs the consumer of the corresponding levels of oxidation, which may be presented as efficacy values on a residual value table.

Further, such removable fiber optic probes may be provided as a permanent part of a sealed consumables and cosmetic substance package, wherein the portions of the probe required to interface with the consumables and cosmetic substance are in direct contact with the consumables and cosmetic substance, and the mating coupler that allows removable attachment to the sensor coupler provided with the smartphone is available externally of the package. Permanently incorporating the removable sensor probe into the package has many benefits for a consumer. The portion of the sensor probes in contact with the consumables and cosmetic substance can be tailored to the specific product and package, while the mating coupler on the outside of the package is always provided in the configuration compatible with the sensor coupler on the smartphone. This enables sensing of a wide array of packaged consumables and cosmetic substances without disrupting package integrity. Further, smartphones are currently provided with displays, spot lights, and cameras that can be coupled to accommodate a wide variety of sensing methodologies without modification of the smartphone. It also simplifies the task greatly for a consumer, and ensures consistent and accurate sensing technique. For example, a pharmaceutical process engineer may wish to check the dissolved sugar content of a liquid reagent provided in a package with a sensor probe using his smartphone. Using his smartphone, he is notified to attach the sensor coupler of his smartphone to the mating sensor probe coupler on the outside of the wine bottle, for instance, extending from its cork. He attaches the probe coupler of the package to the sensor coupler of his smartphone. The probe coupler provided with the package has portions in contact with the dissolved sugar contained therein, which enables the sensing of color transmission values from the sensor probe when the color sensor is activated. The currently sensed color values are compared to a consumables and cosmetic substance attribute library of sensed color transmission data for known reagents with different concentrations of dissolved sugar. When a matching dataset is identified, the smartphone informs the consumer of the corresponding reagent and sugar content, which may be presented by the smartphone as a residual value table corresponding to the efficacy value of the sugar. In another example, the consumer may wish to check the extent of oxidation of a wound dressing provided in a package with a sensor probe using his smartphone. Using his smartphone, he is notified to couple the sensor coupler of his smartphone to the mating sensor probe coupler on the outside of the wound dressing package, for instance, extending from an end portion of the package. He attaches the probe coupler of the wound dressing package to the sensor coupler of his smartphone. The probe coupler provided with the wound dressing package has portions in contact with the wound dressing contained therein, which enables the sensing of reflected color values from the wound dressing when the color sensor is activated. The currently sensed color values are compared to a consumables and cosmetic substance attribute library of sensed reflected color data for known wound dressings. When a matching dataset is identified, the smartphone informs the consumer of the corresponding type of wound dressing and the extent of oxidation, which may be presented as the wound dressing's current residual efficacy value by a residual value table.

It is understood that the present inventions are not limited in scope by the examples of sensors and sensor probes disclosed herein. Consumables and cosmetic substance packages may be provided with sensor probe portions of any known sensing technology in contact with the consumables and cosmetic substance contained therein, and further provided with the ability to communicate sensed values to a smartphone by any known mechanism, including, but not limited to, optic coupling, electronic coupling, acoustic coupling, mechanical coupling, non-contact coupling such as RF, Bluetooth, inductive field, or any other non-contact coupling, and so forth.

Further, it is understood that many other sensing capabilities and sampling formats may be employed. It is also understood that the current inventions enable users to determine corroborating evidence of the authenticity of consumables and cosmetic substances they are about to consume and current residual values for dynamically changing and evolving efficacy values of consumables and cosmetic substances. Such changes and evolution may be through expected degradation, such as a multivitamin losing its vitamin-C value or probiotics losing active microorganisms, may be through unexpected degradation, such as oxidation resulting from a broken package seal, or may be through maturation, such as evolving residue levels in some pharmaceuticals. Determination of a current efficacy value of consumables and cosmetic substances provides information regarding changes that have occurred in corresponding efficacy values, as well as the corresponding residual efficacy values. Further, this provides useful information regarding best-use, maturation, stabilization, or expiration, of the corresponding efficacy value.

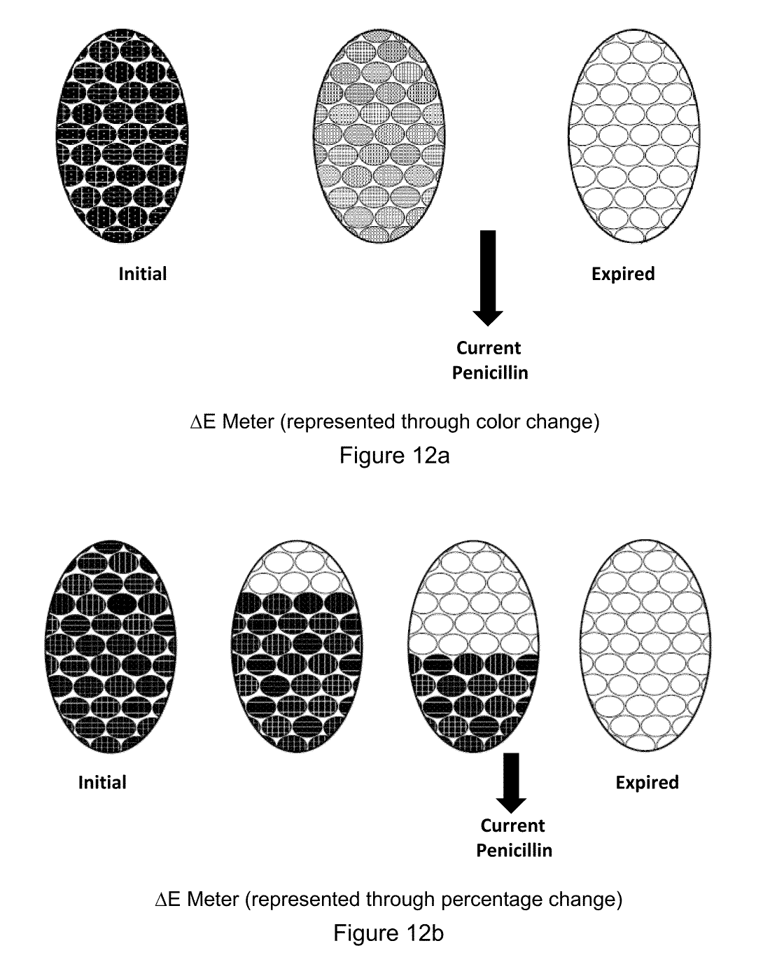

FIGS. 12a and 12b are example formats, provided for illustrative purposes only and not intended to be limiting in any way, showing how a ΔE, and related residual and initial efficacy values, may be expressed. The pill shown in FIGS. 12a and 12b represents an efficacy value associated with a consumables and cosmetic substance. While any object may be chosen to represent an efficacy value, in a preferred embodiment, the chosen object corresponds to a logo, symbol, mascot, or other object associated with a Brand. Such a Brand might be associated with, and provided to enhance and broaden, a consumables and cosmetic substance information system. Alternatively, such a Brand might be associated with a Measurement, Inspection, Engineering, Regulatory, Certification, or other published standard. The object chosen to represent an efficacy value is also referred to herein as a ΔE meter. The ΔE meter shown in FIGS. 12a and 12b provided for illustrative purposes only and not intended to be limiting in any way, is the pill shown in FIGS. 12a and 12b, and corresponds to the logo of the provider of a consumables and cosmetic substance information system.

In FIG. 12a, the ΔE meter communicates various items regarding an efficacy value of a corresponding consumables and cosmetic substance, for the purpose of this example, the Vitamin-C value of a multivitamin provided with a dynamic information identifier. A consumer desiring information regarding Vitamin-C values of the multivitamin can use his smartphone to scan the dynamic information identifier and determine the desired information. In this example, the information is presented to the consumer on the screen of his smartphone in the form of the ΔE meter shown in FIG. 12a. The ΔE meter of this example communicates symbolically through color, and color changes, the initial Vitamin-C value, the current Vitamin-C value, and an expired Vitamin-C value. The values may be shown as relative values without units of measure, as shown, or may further be provided with actual units of measure. In this example, the consumer is provided with a conceptual indicator regarding how much the Vitamin-C value has degraded relative to its initial value and where its current Vitamin-C value is relative to the expiration value of the Vitamin-C.

In FIG. 12b, a ΔE meter communicates various items regarding an efficacy value of a corresponding consumables and cosmetic substance, for the purpose of this example, the Vitamin-C value of a multivitamin provided with a dynamic information identifier. A consumer desiring information regarding Vitamin-C levels of the multivitamin can use his smartphone to scan the dynamic information identifier and determine the desired information. In this example, the information is presented to the consumer on the screen of his smartphone in the form of the ΔE meter shown in FIG. 12b. The ΔE meter of this example communicates symbolically through percent fill-level, and percent fill-level changes, the initial Vitamin-C value, the current Vitamin-C value, and an expired Vitamin-C value. The values may be shown as relative values without units of measure, as shown, or may further be provided with actual units of measure. In this example, the consumer is provided with a conceptual indicator regarding how much the Vitamin-C value has degraded relative to its initial value and where its current Vitamin-C value is relative to the expiration value of the Vitamin-C.

It is understood that ΔE meters may take many forms and communicate various messages regarding a ΔE value or a residual efficacy value of consumables and cosmetic substances, and the examples provided above are for illustrative purposes and not intended to be limiting in any way. It is further understood that ΔE meters may be utilized to communicate ΔE values and residual efficacy values determined or estimated in any fashion. In preferred embodiments, the ΔE value or the residual efficacy value are determined utilizing the consumables and cosmetic substance information systems disclosed herein, including systems utilizing dynamic information identifiers and corresponding consumables and cosmetic substance database, systems utilizing efficacy attribute sensors and corresponding consumables and cosmetic substance attribute library, or a combination of both.

To further illustrate benefits of the present inventions the following example is provided of a consumer who is faced with making consumables and cosmetic substance purchasing decisions based on his unique needs, for example, consumables and cosmetic substances that are organic, if they are vitamin supplements they have high efficacy values related to vitamin C, and if they are skin care products they have high efficacy values for phytochemicals, typically derived from Aloe vera. The consumer uses his smartphone to access a consumables and cosmetic substance information module that has access to a consumer module with the his personal consumer profile, including: consumables and cosmetic substances that are organic; consumables and cosmetic substances that are vitamin supplements to have high efficacy values related to vitamin C; and if they are consumables and cosmetic substances related to skin care to have high efficacy values for phytochemicals. The consumer might use his smartphone to access a database for consumables and cosmetic substances that filters the substances according to his consumer profile, or alternatively, the consumer might use his smartphone to access a database for consumables and cosmetic substances wherein the database provides a consumer interface through the consumer's smartphone screen to provide input regarding the consumer's needs, such as consumables and cosmetic substances that are organic; vitamin supplements with high efficacy values related to vitamin C; and skin care products with high efficacy values for phytochemicals. In this way, the consumer creates a list of consumables and cosmetic substances that meets his essential health needs.

The consumer then uses his smartphone, tablet computer, or personal computer to locate nearby retailers of the items on his list and verify if they have all of the required items. Unfortunately, all of the items are not available at his preferred supermarket, but he finds that they are available at an alternate supermarket nearby. He is not familiar with the alternate supermarket, and does not know the locations of the various items in the unfamiliar supermarket, so in order to make his shopping experience more efficient he uses his smartphone, tablet computer, or personal computer to request the location of the items within the supermarket and the fastest route within the supermarket to collect the items on his shopping list. For example, the consumer's smartphone utilizes an application created for the alternate supermarket to identify the location within the alternate supermarket of the various items on his shopping list and generate a route within the alternate supermarket that the consumer can follow that will result in the least amount of time required for collecting the items. The suggested route may instruct that he starts in isle number 1, and provide the list of items to collect at that location. As he collects the various items required from isle number 1, his smartphone can allow him to delete a collected item, change its status to indicate it has been collected, or may allow him to move it from a list of items to be collected to a list of items collected. Upon collecting the last item from the isle number 1, the smartphone instructs him to go to the specific isle where the next items can be found, which in this case is isle 11. Upon collecting the corresponding items from isle 11, the smartphone instructs him to go to the specific isle where the next items are located, which in this case is isle 14. Upon collecting the corresponding items from isle 14, the smartphone instructs him to go to the specific isle where the next items can be found, in this case isle 15. In this way, the consumer's time spent locating and collecting the items required for purchase is minimized because he is able to make one quick pass through the supermarket, visiting only the correct location for each item, and with no backtracking. Additionally, his smartphone can easily verify that all required items have been collected. Further, his smartphone can be used to retrieve a dynamic information identifier from each consumables and cosmetic substance considered for purchase so that he may retrieve related source, origin, and creation information and ΔE information from a consumables and cosmetic substance database in the consumables and cosmetic substance information module. Preferably, the consumables and cosmetic substance is provided with a QR code including the dynamic information identifier and a URL to hardlink the consumer to the consumables and cosmetic substance database. The consumer would use his smartphone to scan such a QR code on a consumables and cosmetic substance of interest. The smartphone would then hardlink the consumer to the consumables and cosmetic substance database and retrieve source and ΔE information associated with the dynamic information identifier, thereby confirming that the corresponding item meets his needs.

If no single supermarket has all of the items on his list, the consumer can still retrieve a route requiring the least time to collect the items from multiple supermarkets or other retailers. For example, if the consumer must visit two supermarkets to collect all items, the route retrieved can include both the driving instructions from the consumer's home to a first supermarket, the route to follow within the first supermarket, driving instructions from the first supermarket to a second supermarket, the route to follow within the second supermarket, and driving instructions from the second supermarket to the consumer's home. Further, his smartphone can be used to retrieve a dynamic information identifier from any consumables and cosmetic substance provided with a dynamic information identifier so that he may retrieve related source and ΔE information from the consumables and cosmetic substance database. Preferably, the consumables and cosmetic substance is provided with a QR code including the dynamic information identifier and a URL to hardlink the consumer to the consumables and cosmetic substance database.

The consumer goes to the supermarket to purchase the items on his list. The list calls for laundry detergent. The consumer uses his smartphone to scan a dynamic information identifier on laundry detergent, such as by scanning a QR code including the dynamic information identifier and a URL to hardlink the consumer to the consumables and cosmetic substance database to verify if the laundry detergent will meet his need for organic substances, and finds that it does not, based upon the source information retrieved. The consumer may then use his smartphone to scan a dynamic information identifier on another brand of laundry detergent, such as by scanning a QR code including the dynamic information identifier and a URL to hardlink the consumer to the consumables and cosmetic substance database and finds that the alternate box is organic, based upon the source information retrieved, and therefore decides to purchase the alternate box of laundry detergent. In a similar fashion, the consumer scans a QR code including a dynamic information identifier and URL for the consumables and cosmetic substance database on one or more vitamin products, accesses the consumables and cosmetic substance database and finds out if the products meet, or do not meet, his organic requirement and his need for vitamin supplements with high efficacy values related to vitamin C, and then makes purchasing decisions regarding the corresponding vitamin product. In a similar fashion, the consumer scans a QR code including a dynamic information identifier and URL for the consumables and cosmetic substance database on one or more skin care products, accesses the consumables and cosmetic substance database and finds out if the products meet, or do not meet, his organic requirement and his need for skin care products with high efficacy values related to phytochemicals, and then makes purchasing decisions regarding the corresponding skin care product. The consumer is not the only entity that has benefited from the source and dynamic efficacy information about the laundry detergent, the vitamin product, and the skin care product, as data regarding the consumer's general need for organic, vitamin supplement need for high efficacy related to vitamin C, and skin care product need for high efficacy value related to phytochemicals have been collected by the consumer module and correlated with the respective dynamic information identifiers, and are available to, such as transmitted to, the information module, also referred to herein as the consumables and cosmetic substance industry database, and are of particular interest and accessible to the creators, transformers, and preservers of the respective items. The consumables and cosmetic substance database can further provide ΔE information regarding how the efficacy values of any of the items he is buying are expected to evolve, such as with time. This consumer information can be saved and be made available to all other entities in the consumables and cosmetic substance supply system.

Some of the items on the consumer's list may be consumables and cosmetic substances that mature as they age, such as to increase their efficacy value as they discompose. Using his smartphone to read QR codes (providing dynamic information identifiers and URL to the consumables and cosmetic substance database) form packages of such substances he is considering for purchase, he can retrieve information from the consumables and cosmetic substance database with his smartphone regarding source and ΔE information of those products, and can make informed decisions on the maturity of the corresponding product.

When the consumer is ready to consume the products he has purchased, he uses his smartphone to read QR codes (providing dynamic information identifiers and URL to the consumables and cosmetic substance database) from the specific product in order to access the consumables and cosmetic substance database containing dynamic efficacy values for the product identified by the specific dynamic information identifier. The consumables and cosmetic substance database has source and ΔE information regarding changes efficacy levels of the corresponding product, and uses that information to modify a dispensing protocol, such that a desired amount of efficacy content is adaptively dispense responsive to the ΔE information. Further, the consumer's preference for a particular amount of efficacy content may be available as part of a consumer specific profile within the consumer module, or may result from a query required by the dispensing protocol, such that the corresponding consumables and cosmetic substance is adaptively dispensed responsive to the ΔE information and the consumer's input. The dispensing protocol associated with the item chosen by the consumer is provided through the consumer's smartphone.

To illustrate other benefits of the present inventions, another example is provided of a consumer who is faced with making a consumption decision regarding a consumables and cosmetic substance he has already purchased. In this example, a consumer has purchased skin lotion. The consumer knows that a vitamin supplement he has purchased loses its efficacy value related to vitamin C, and does not want them to become unacceptably low prior to consumption. In this case, knowing a dynamic expiration date, that is, an actual “best use” date, for the vitamin supplement, based on its efficacy value related to vitamin C value, would be far more valuable than the static expiration information currently available. The consumer could use his smartphone to read a QR code (providing dynamic information identifiers and URL to the consumables and cosmetic substance database) from the vitamin supplement he has purchased, and find that based upon dynamically generated data available through the dynamic efficacy value database in the consumables and cosmetic substance database, the efficacy value related to vitamin C in the vitamin supplement will expire in the next two weeks. This dynamic expiration information would alert the consumer that the actual “best use” date is close, and he should consider using the vitamin supplement soon. Here again, the consumer is not the only entity that has benefited from the dynamic efficacy information about the vitamin supplement, as data regarding the consumer's needs for vitamin supplements with high efficacy value related to vitamin C have been collected by the consumer module and correlated with the respective dynamic information identifiers, and are available and of particular interest to the creators, transformers, and preservers of the vitamin supplement.

To illustrate additional benefits of the present inventions the following example is provided of a hospital that is faced with making a purchasing decision regarding a type of drug it is considering for purchase. In this example, a hospital considers the purchase of the drug from two different suppliers. The hospital knows that this drug typically loses its efficacy value in a short time, and does not want them to expire before use. In this case, knowing a dynamic expiration date, that is, an actual “best use” date, for the drugs would be far more valuable than static expiration information currently available to the hospital, and more valuable than simply following FIFO inventory practices. The hospital could use the dynamic information identifier for the drugs it is contemplating for purchase, such as by scanning a QR code received by facsimile or e-mail or downloaded from the supplier's website, and find that based upon dynamically generated data available through the dynamic efficacy value database in the consumables and cosmetic substance database, the efficacy value of the drugs from one supplier will expire 1 week earlier than their expected use cycle, while the drugs from the other supplier will not expire until 1 week past their expected use cycle, and in addition would find the actual ΔE curve or residual value table of what it means for the efficacy values when the drugs from both suppliers expire. This dynamic expiration information would inform the hospital's purchasing decision. The hospital is not the only entity that has benefited from the dynamic efficacy information about the drugs, as data regarding the hospital's preference for extended dynamic expiration dates is also available, and of particular interest, to the creators, transformers, and preservers of the respective drugs. The creators, transformers, and preservers of the products with longer dynamic shelf life can additionally require a premium price for their products.

To illustrate still other benefits of the present inventions the following example is provided of a consumer who purchases an information enabled skin lotion with Aloe vera and uses a dispenser that is capable of dispensing information enabled consumables and cosmetic substances to deliver the skin lotion. The consumer goes to the supermarket seeking a particular type of information enabled skin lotion. His selection process includes using a smartphone to read a QR code (providing dynamic information identifiers and URL to the consumables and cosmetic substance database) from the information enabled skin lotion with Aloe vera, wherein his smartphone retrieves information from the consumables and cosmetic substance database, and verifies that the skin lotion meets his needs, particularly his needs related to the efficacy value of the skin lotion associated with phytochemicals. The consumer later uses a dispenser that is capable of dispensing information enabled consumables and cosmetic substances to dispense the skin lotion with Aloe vera. In the process of dispensing the skin lotion with Aloe vera, the dispenser reads the dynamic information identifier from a QR code on the skin lotion with Aloe vera. Using the dynamic information identifier the microwave retrieves information from the consumables and cosmetic substance database regarding the skin lotion with Aloe vera such as ΔE information and corresponding residual efficacy values. The dispenser then provides the consumer options related to the amount of efficacy content to be delivered. This will enable the consumer to input a preference related to dispensing the skin lotion with Aloe vera. The dispenser can now adaptively dispense an amount of skin lotion that is responsive to the ΔE information and corresponding residual efficacy values and the consumer's input. When the dispenser finishes adaptively dispensing the skin lotion with Aloe vera, it also provides the information regarding the skin lotion with Aloe vera it received from consumables and cosmetic substance database along with information it collected regarding the dispensing of the skin lotion with Aloe vera to the consumer module, which could be a smartphone or tablet computer. The consumer module, for example the consumer's smartphone, would obtain consumer information regarding the consumption of the skin lotion with Aloe vera. The smartphone can additionally obtain information relevant to the skin lotion with Aloe vera, which may include consumer feedback, observations, or measurements related to the efficacy value of the skin. The consumer module can share this information, through the information module, with those in the consumables and cosmetic substance supply chain responsible for the skin lotion with Aloe vera.

As mentioned above, a consumer utilizing the consumer information system can benefit from in-store routing technologies to assist his efforts to efficiently locate and purchase consumables and cosmetic substances. An in-store routing technology placing little to no burden on the consumer, placing little to no burden on the retailer, facilitating improved shopping efficiency, and further allowing monetary benefit to both retailer and consumer based on transactions would favor adoption. Ideally, the consumer would be able to utilize his smart phone to navigate within any establishment that was appropriately navigation enabled. Ideally, the retail establishment would require no additional equipment or infrastructure to become navigation enabled.

A technology that can provide these advantages is ambient magnetic field anomaly-based positioning. The technology utilizes local variations in the Earth's magnetic field to map an indoor location. Variations to the Earth's magnetic field commonly exist inside of modern buildings and are a result of the overall structures of the building. The Earth's magnetic field and the magnetic anomalies created by a specific building create a unique three dimensional magnetic footprint of the interior of the building. Evolving software applications combined with smartphones capable of sensing and recording the resulting magnetic field anomalies can be used to map indoor locations. IndoorAtlas, Ltd. is a company that offers software tools enabling this technology, allowing retailers to magnetically map the interior of a building, such as a modern supermarket, using an Android smartphone and enabling consumers to navigate the interior of the building using their Android smartphone. Depending on the type of building, the accuracy of the technology in modern buildings ranges from 0.1 meter to 2 meters.

This enables the creation of indoor location-awareness applications to enhance the consumer's shopping experience, for example, at a supermarket. Such applications could provide the consumer not only with the availability and location of items on the consumer's shopping list, but with the most efficient route to follow within the supermarket when collecting the items, even leading them on the best route within the supermarket. Further, such applications could identify product alternatives, price, price per unit, promotions such as product rebates, transaction rebates specific to use of the application, and could further suggest complimentary items which are likely to accompany or enhance a target item.

Ideally, the consumables and cosmetic substances identified would only include consumables and cosmetic substances with dynamic information identifiers on the product itself, enabling the consumer to retrieve source and ΔE information from the consumables and cosmetic substance database using their smartphone. If consumables and cosmetic substances with and without dynamic information identifiers were identified, a transaction rebate related to the purchase of consumables and cosmetic substances with dynamic information identifiers could be available.

Examples of how a consumer might benefit from utilizing such an indoor location-awareness application are now provided. The examples will focus on an application that works with the consumer's smartphone in an appropriately navigation enabled supermarket, such as a navigation-enabled supermarket enabled by IndoorAtlas' navigation software.

The consumer can use an indoor location-awareness application to create a shopping list for consumables and cosmetic substances and identify the supermarket where he will shop. Alternatively, the consumer could create the shopping list and identify the supermarket where he will shop using other software and send it to the indoor location-awareness application. Using information regarding the contents of the chosen navigation-enabled supermarket the application creates a modified shopping list. The modified shopping list includes the primary items from the consumer's shopping list, and in some cases, variations or alternatives of those items. Further, the modified shopping list may include added items that are complimentary to the primary and alternative items. For example, hair conditioner with Aloe vera could be suggested as a complementary item to skin lotion with Aloe vera on the shopping list. Using the modified shopping list, the consumer can see and compare price or price per unit of items on list, including rebates associated with each item, which items can be purchased with an electronic coupon provided by the application, or which items are supplied with a dynamic information identifier. It is preferable that the modified shopping list is generated and presented to the consumer before the consumer begins shopping, in which case the consumer may select various primary, alternative, and complementary items. When the consumer has accepted items from the modified shopping list to create a final list, the application can generate the best in-store route to retrieve the items. The application can still retrieve and still show the items not accepted, in case the consumer wants to reconsider an item while shopping.

The consumer now has a highly evolved shopping plan, which takes into consideration various product criteria and provides a targeted in-store route by which to retrieve the items. As the consumer follows the in-store route and collects items from the final list, he can indicate through his smartphone that the items have been collected. He may also encounter an item on the final list that he decides not to purchase. For example, he might remember that he already has a particular item at home, in which case he can create a modified final list by deleting the item. The application could then generate a new in-store route based upon the modified final list, which includes the remaining items and the consumer's current location. Alternatively, he may utilize his smartphone to read a QR code with the item's dynamic information identifier and URL to the consumables and cosmetic substance database to retrieve source or ΔE information regarding an item from the consumables and cosmetic substance database and decide he is no longer interested and would rather consider a previously identified alternative item. In this case, he could create a modified final list by accepting the alternative item still shown on the final list and unselecting the item he has lost interest in. The application could then generate a new in-store route based upon the modified final list, which includes the newly accepted item, the remaining items, and the consumer's current location. In still another alternative, the consumer may remember an item that was not originally on his shopping list and add it to the final list, creating a modified final list. The application could then generate a new in-store route based upon the modified final list, which includes the newly added item, the remaining items, and the consumer's current location.

Rebates related to transactions resulting from or assisted by the use of the application could be structured in various ways. For example, rebates could be based simply on a rebate per purchase methodology. Rebates might be structured depending upon hierarchy of the item on the consumer's shopping list, for example depending upon if the purchased item was a primary shopping list item, an alternative item, or a complimentary item. Rebates could be related to the presence of a dynamic information identifier on the purchased item. Rebates could be related to specific supplier or in-store promotions presented to the consumer through the application.

After check out, the consumer can scan the receipt using his smartphone and transmit the information regarding purchases resulting from or assisted by the use of the application to a redemption resource, which could be the application provider. Alternatively, the supermarket could transmit this information along with a consumer identification code. This would ideally enable the application provider to redeem fees from the suppliers of the items purchased. The application provider would in turn provide the appropriate rebates to the consumer. The consumer rebates may take any number of forms, including direct deposit to a consumer account, periodic checks, or credit codes redeemable at suppliers or supermarkets participating in the application rebate program. Further, the application provider would provide monetary compensation to the retailer or supermarket for transactions resulting from or assisted by the use of the application. These transaction-based services are enhanced by the usage of ambient magnetic field anomaly-based positioning technology, since the routing to products is independent of in-store communication systems provided by a retailer and, also, independent of systems based upon GPS or other triangulation technologies. Thus, the transaction-based services using ΔE information can be readily associated with, or coupled to, the application using the ambient magnetic field anomaly-based positioning technology.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. Any claims intended to be treated under 35 U.S.C. §112, ¶6 will begin with the words “means for.” Accordingly, the applicant reserves the right to add additional claims after filing the application to pursue such additional claim forms for other aspects of the invention.

1. A system for dynamically determining content and an efficacy state of consumables and cosmetic substances, comprising:
a menu panel for providing a means for obtaining a consumer's input regarding a consumables and cosmetic substance and communicating at least two of a means for providing a corroboration of content and means for providing a current efficacy state of the consumables and cosmetic substance based upon changes in the efficacy state of the consumables and cosmetic substance; and
at least one consumables and cosmetic substance attribute sensor for sensing at least one consumables and cosmetic substance attribute value corresponding to the current state of the consumables and cosmetic substance; and
a transmitter for transmitting information related to changes in the efficacy state of the at least one consumables and cosmetic substance attribute value and the consumer's input.

2. A system for dynamically determining content and an efficacy state of consumables and cosmetic substances according to claim 1, wherein
the menu panel and the transmitter are provided with a smartphone for enabling a consumer to dynamically sense ΔE information as requested.

3. A system for dynamically determining content and an efficacy state of consumables and cosmetic substances according to claim 2, wherein
the at least one consumables and cosmetic substance dynamic attribute sensor is provided with the smartphone.

4. A system for dynamically determining content and an efficacy state of consumables and cosmetic substances according to claim 2, wherein
the at least one consumables and cosmetic substance dynamic attribute sensor is in communication with the smartphone.

5. A system for dynamically determining content and an efficacy state of consumables and cosmetic substances according to claim 1, further comprising
a database of consumables and cosmetic substance attribute values corresponding to known consumables and cosmetic substances at known efficacy states.

6. A system for dynamically determining content and an efficacy state of consumables and cosmetic substances, comprising:
a menu panel for obtaining a consumer's input regarding a consumables and cosmetic substance and communicating a corroboration of the consumables and cosmetic substance content and a current efficacy state of the consumables and cosmetic substance; and
a detector portion of a consumables and cosmetic substance attribute sensor for detecting a consumables and cosmetic substance attribute value from a probe portion of the consumables and cosmetic substance attribute sensor; and
a transmitter for transmitting information related to the at least one consumables and cosmetic substance attribute value and the consumer's input.

7. A system for dynamically determining content and an efficacy state of consumables and cosmetic substances according to claim 6, wherein
the menu panel, the detector portion, and the transmitter are provided with a smartphone.

8. A system for dynamically determining content and an efficacy state of consumables and cosmetic substances according to claim 6, wherein
the probe portion is provided with a smartphone.

9. A system for dynamically determining content and an efficacy state of consumables and cosmetic substances according to claim 6, wherein
the probe portion is provided as a smartphone accessory.

10. A system for dynamically determining content and an efficacy state of consumables and cosmetic substances according to claim 6, wherein
the probe portion is part of a consumables and cosmetic substance package.

11. A system for dynamically determining content and an efficacy state of consumables and cosmetic substances according to claim 6, further comprising
a database of consumables and cosmetic substance attribute values corresponding to known consumables and cosmetic substances at known efficacy states.

12. A system for adaptively dispensing consumables and cosmetic substances comprising:
a menu panel for obtaining a consumer's input regarding a consumables and cosmetic substance and communicating a current efficacy state of the consumables and cosmetic substance; and
at least one consumables and cosmetic substance attribute sensor for sensing at least one consumables and cosmetic substance attribute value corresponding to the current state of the consumables and cosmetic substance; and
a database of consumables and cosmetic substance attribute values corresponding to known consumables and cosmetic substances at known efficacy states.

13. A system for adaptively dispensing consumables and cosmetic substances according to claim 12, wherein
the menu panel and the at least one consumables and cosmetic substance attribute sensor are provided with a smartphone.

14. A system for adaptively dispensing consumables and cosmetic substances according to claim 13 wherein
the menu panel communicates to the consumer an adaptive dispensing sequence responsive to the at least one consumables and cosmetic substance attribute value and the consumer's input.

15. A system for adaptively dispensing consumables and cosmetic substances according to claim 13 wherein
the smartphone implements an adaptive dispensing sequence responsive to the at least one consumables and cosmetic substance attribute value and the consumer's input, through a communication compatible dispensing appliance.
